(19) United States
(12) Patent Application Publication
(10) Pub. No.: US 2016/0365184 A1
(43) Pub. Date: Dec. 15, 2016

(54) MAGNET STORAGE DEVICE

(71) Applicant: All About Packaging, Inc., Appleton, WI (US)

(72) Inventors: Thomas P. Schein, Neenah, WI (US); Brent J. Grinwald, Oshkosh, WI (US)

(21) Appl. No.: 15/211,391

(22) Filed: Jul. 15, 2016

Related U.S. Application Data
(63) Continuation-in-part of application No. 13/602,306, filed on Sep. 3, 2012.
Application No. 13/602,306 is a continuation-in-part of application No. 12/930,324, filed on Jan. 3, 2011, now Pat. No. 8,256,618.
(60) Provisional application No. 61/401,402, filed on Aug. 11, 2010.

(51) Int. Cl. H01F 7/02; B65D 73/00; B65D 79/00; B65D 75/36; B65D 75/56

(52) U.S. Cl. CPC H01F 7/02; B65D 75/366; B65D 75/566; B65D 79/00; B65D 73/0035

(57) ABSTRACT

A magnetic storage device is disclosed which is capable of retaining at least one article having a magnetic affinity. The magnetic storage device includes a magnet, a base having a channel formed therein which is sized and configured to retain the magnet, and a tray. The tray has a front face with a first opening and a second opening formed therein. The tray engages the base and is held secure thereto with the magnet sandwiched in between. The first opening is semi-cylindrical in configuration and overlies the magnet. The second opening is cylindrical in configuration and is aligned perpendicular to the first opening. The second opening has a bottom wall. The magnet exerts a sufficient magnetic attraction on an article when the article is positioned into one of the first or second openings to temporarily retain the article in the magnetic storage device.

### CROSS-REFERENCE TO RELATED PATENT APPLICATIONS

The present Continuation-In-Part patent application claims priority under 35 USC Section 120 from co-pending U.S. Ser. No. 13/602,306 filed on Sep. 3, 2012 by Thomas P. Schein and Brent J. Grinwald and entitled: MAGNETIC STORAGE DEVICE; which in turn claims priority from U.S. Pat. No. 8,256,618, filed on Jan. 3, 2011; which in turn claims priority from U.S. Provisional Application 61/401,402 filed on Aug. 11, 2010.

### BACKGROUND OF THE INVENTION

Magnetic storage devices are sometimes utilized to store articles or article having a magnetic affinity. Such storage devices may be difficult and complex to manufacture, may not be suited for all types of articles and may not provide intuitive removal of articles from the storage device or attachment of articles to the storage device.

### BRIEF DESCRIPTION OF THE DRAWINGS

FIG. 1 is a perspective view of a magnetic storage device capable of retaining a plurality of articles each having a magnetic affinity.

FIG. 2 is a cross-sectional view of the magnetic storage device shown in FIG. 1 taken along line 2-2.

FIG. 3 is a cross-sectional view of an alternative embodiment of the magnetic storage device shown in FIG. 1.

FIG. 4 is a perspective view of an elongated magnet having a rectangular cross-section.

FIG. 5 is a front view of another embodiment of a magnetic storage device.

FIG. 6 is a right side view of the magnetic storage device shown in FIG. 5.

FIG. 7 is a perspective view of the magnetic storage device shown in FIG. 5.

FIG. 8 is a cross-sectional view of the magnetic storage device taken along line 8-8 of FIG. 9 is an exploded view of the magnetic storage device shown in FIG. 5.

FIG. 10 is a perspective view of four magnetic storage devices connected together and with each device retaining batteries of a different size.

FIG. 11 is a perspective view of still another embodiment of a magnetic storage device which is capable of retaining a plurality of different size articles.

FIG. 12 is a perspective view of a base unit of a magnetic storage device.

FIG. 13 is a perspective view of a magnetic storage device.

FIG. 14 is a perspective view of a magnetic storage device.

FIG. 15 is a perspective view of a magnetic storage device.

FIG. 16 is a perspective view of a magnetic storage device.

FIG. 17 is a perspective view of a magnetic storage device.

FIG. 18 is a perspective view of a magnetic storage device.

FIG. 19 is a perspective view of a magnetic storage device.

FIG. 20 is a perspective view of a magnetic storage device.

FIG. 21 is a perspective view of a magnetic storage device.

FIG. 22 is a perspective view of a magnetic storage device in an opened state.

FIG. 23 is a perspective view of the magnetic storage device of FIG. 22 in a closed state.

FIG. 24 is a perspective view of a magnetic storage device in an opened state.

FIG. 25 is a perspective view of the magnetic storage device of FIG. 24 in a closed state.

FIG. 26 is a perspective view of a magnetic storage device in an opened state.

FIG. 27 is a perspective view of the magnetic storage device of FIG. 26 in a closed state.

FIG. 28 is a perspective view of a magnetic storage device in an opened state.

FIG. 29 is a perspective view of the magnetic storage device of FIG. 28 in a closed state.

FIG. 30 is a perspective view of a magnetic storage device.

FIG. 31 is a perspective view of a magnetic storage device.

FIG. 32 is a perspective view of a magnetic storage device.

FIG. 33 is a perspective view of a magnetic storage device.

FIG. 34 is a perspective view of a magnetic storage device.

FIG. 35 is a perspective view of a magnetic storage device.

FIG. 36 is a perspective view of a magnetic storage device.

FIG. 37 is a perspective view of a magnetic storage device.

FIG. 38 is a perspective view of a magnetic storage device.

FIG. 39 is a perspective view of a magnetic storage device.

FIG. 40 is a perspective view of a magnetic storage device.

FIG. 41 is a perspective view of a magnetic storage device.

FIG. 42 is a perspective view of a magnetic storage device.

FIG. 43 is a perspective view of a magnetic storage device.

FIG. 44 is a perspective view of a magnetic storage device.

FIG. 45 is a perspective view of a magnetic storage device.

FIG. 46 is a perspective view of a magnetic storage device.

FIG. 47 is a perspective view of a magnetic storage device.

FIG. 48 is a perspective view of a magnetic storage device.

FIG. 49 is a perspective view of a magnetic storage device.

FIG. 50 is a perspective view of a magnetic storage device for storing articles.

FIG. 51 is a perspective view of the magnetic storage device of FIG. 50 omitting the articles.

FIG. 52 is an exploded perspective view of the magnetic storage device shown in FIG. 51.

FIG. 53 is a sectional view of the magnetic storage device of FIG. 51 taken along line 53-53.

FIG. 54 is a perspective view of a magnetic storage device in an opened state and containing articles.

FIG. 55 is an exploded perspective view of the magnetic storage device and articles of FIG. 54.

FIG. 56 is a perspective view of the magnetic storage device of FIG. 54 in a horizontal orientation and in a closed state.

FIG. 57 is a perspective view of the magnetic storage device of FIG. 54 in a vertical orientation and in an opened state.

FIG. 58 is a first perspective view of a magnetic storage device.

FIG. 59 is a second perspective view of the magnetic storage device of FIG. 57.

FIG. 60 is a front view of the magnetic storage device of FIG. 58.

FIG. 61 is a top view of the magnetic storage device of FIG. 58.

FIG. 62 is a rear side view of the magnetic storage device of FIG. 58.

FIG. 63 is an exploded perspective view of the magnetic storage device of FIG. 58.

FIG. 64 is a sectional view of the magnetic storage device of FIG. 58.

### DETAILED DESCRIPTION OF THE INVENTION

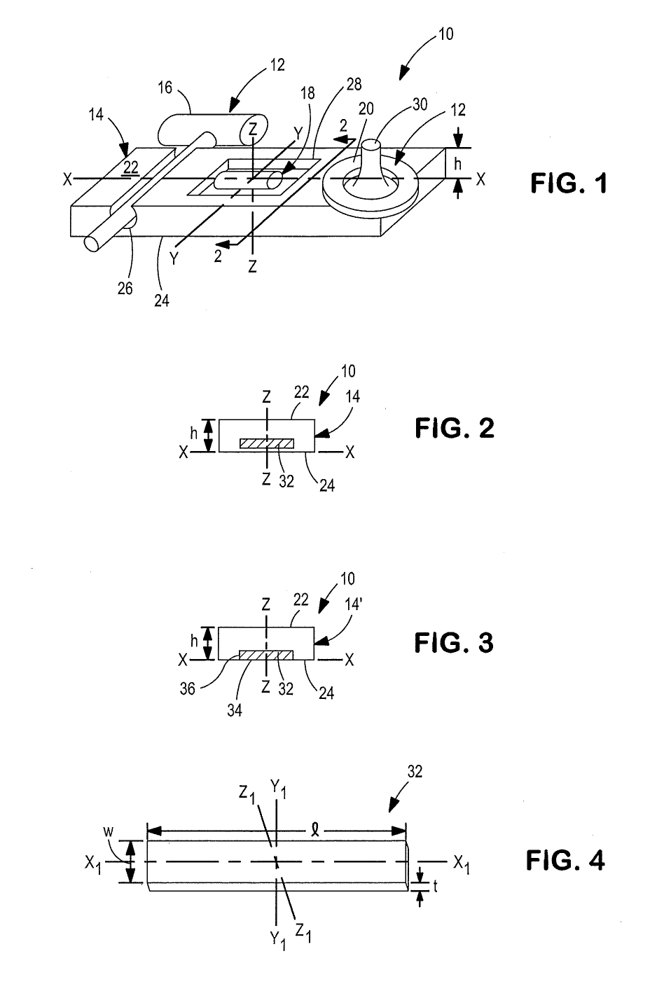

Referring to FIG. 1, a magnetic storage device 10 is shown which is capable of retaining at least one article 12, and desirably a plurality of articles 12, each having a thickness and a magnetic affinity. By “article” it is meant an individual thing or element of a class; a particular item. For example, the article 12 could be a tool, including but not limited to, a wrench, a socket, a socket head which can be connected to a socket wrench, a drill, a drill bit, a screwdriver, a screwdriver bit, a pair of pliers, a tool having a stem, shank or handle, or any other kind of tool. In addition, the article 12 could be a kitchen utensil, a battery, a key, a medal, a small part, a sporting goods such as hunting and fishing accessories, a bullet, a shotgun shell, a fishing lure, a fishing hook, a fishing fly, etc. The article 12 could also be an item needed for a particular hobby; an item associated with a particular activity or interest; an item needed to perform one's professional job, such as medical or dental instruments; an item needed to make or repair equipment such as jewelry components; a figurine such as toy metal soldiers; tie clips; bow ties or any item that includes a metal or iron part, or contain a metal coating. Furthermore, the article 12 could be any of various hardware items such as: a metal fastener, a metal stud, a cylindrical metal bar, a washer, a nut, a bolt, a screw, a pin, a nail, etc. Those skilled in the art will be aware that the article 12 can be almost any item created by man.

The magnetic storage device 10 includes a three-dimensional (3D) tray 14 with a longitudinal central axis X-X, a transverse central axis Y-Y and a vertical central axis Z-Z. The tray 14 is capable of holding or retaining one or more of the articles 12. Desirably, the tray 14 can retain a plurality of articles 12. Each of the articles 12 can be identical, similar or different in size, shape, type, kind and/or construction. In FIG. 1, three articles 12 are depicted, each of which varies in size, shape and kind. The left most article 12 is a hammer 16; the central article 12 is a cylindrical pin 18; and the right most article 12 is a washer 20.

Typically, one or more articles 12 will be packaged in the magnetic storage device 10. Desirably, two or more articles 12 will be packaged in the magnetic storage device 10. Even more desirably, several articles 12 will be packaged in the magnetic storage device 10. Most desirably, a plurality of articles 12 will be packaged in the magnetic storage device 10. The actual number of articles 12 retained, housed or stored in the magnetic storage device 12 can vary from one article to many articles. In some instances, the magnetic storage device 10 can hold a dozen or more articles 12, and in some instances, the magnetic storage device 10 can hold over a hundred small articles 12 depending upon the size and configuration of the articular articles 12.

The articles 12 can be formed, molded, manufactured, assembled and/or constructed such that at least a portion of each article 12 is formed from or contains a metal, such as iron or a metal oxide. Each article 12 could also contain a ferric or ferrous substance, include ferrous oxide or some other metal oxide, or be ferromagnetic. By “ferric” it is meant of or relating to, or containing iron, especially with a valence of 3 or a valence higher than in a corresponding ferrous compound. By “ferrous” it is meant of or relating to, or containing iron, especially with a valence of 2 or a valence lower than in a corresponding ferric compound. Alternatively, a portion of the outer periphery of an article 12 can contain a metal coating. Still further, a metal chip could be partially or fully inserted into each article 12 so that it has an affinity to a magnet. Each article 12 has a magnetic affinity. By “magnetic affinity” it is meant the article 12 has a natural attraction to a magnet or magnetic member or magnetic substance. Each of the articles 12 can have a magnetically attractive portion or surface. Desirably, each of the articles 12 is constructed partially or totally out of metal or steel, or includes a metal chip, or contains a metal coating. The amount of metal from which each of the articles 12 is formed, or the amount of metal inserted into each of the articles 12, or the amount of metal coated onto each of the articles 12 can vary. Desirably, each article 12 has a metal content that is equal to at least about 5% of the article's total weight. When a metal coating is utilized which is sprayed, brushed, coated or somehow adhered to at least a portion of the outer periphery of the article 12, the actual amount of metal present can be even less than about 5% of the article's total weight. For example, the metal coating may constitute only about 3% of the article's total weight. Desirably, the amount of metal contained in each of the articles 12 or the amount of metal coating adhered to each of the articles 12 will range from between about 3% to about 100% of the article's total weight. More desirably, the amount of metal contained in each of the articles 12 or the amount of metal coating adhered to the articles will range from between about 5% to about 100%. Even more desirably, the amount of metal contained in of each of the articles 12 or the amount of metal coating adhered to the articles will range from between about 10% to about 100%.

When the article 12 is a tool, such as a wrench, the article 12 can contain from about 25% to about 100% metal. Desirably, when the article 12 is a tool, the article 12 can contain from about 50% to about 100% metal. More desirably, when the article 12 is a tool, the article 12 can contain from about 75% to about 100% metal.

Still referring to FIG. 1, the tray 14 can be formed using various processes known to those skilled in the art. Injection molding and thermoforming are two common methods that can be employed to construct the magnetic storage device 10. The magnetic storage device 10 can be constructed from one or more materials. Such material(s) include but are not limited to: a plastic such as a polyolefin, polyethylene, polypropylene or a combination thereof; a thermoplastic; a clear plastic; a transparent plastic; a colored plastic; stamped sheet metal; a metal or a metal alloy; aluminum or an aluminum alloy; wood; glass; fiberglass; plywood; paper; paperboard; cardboard; veneer; a composite material; a fabric; a leather; etc. Desirably, a portion of the magnetic storage device 10 is constructed from a clear or transparent material, such as plastic, so that the article 12 retained therein is visible to the naked eye.

Alternatively, the magnetic storage device 10 could be made from a single material embedded with a permanent magnet or a permanent magnetic powder. The material would likely be considered a binder, such as an epoxy. The combination of magnetic material and binder could be molded, machined or die-pressed into a desired shape.

Still referring to FIG. 1, the tray 14 has an upper surface 22, a lower surface 24 and a height h therebetween. The overall geometrical configuration of the tray 14 can vary. Likewise, the height h can vary in dimension. Desirably, the height h of the tray 14 is at least about 0.25 inches. More desirably, the height h of the tray 14 is at least about 0.5 inches. Even more desirably, the height h of the tray 14 is at least about 0.75 inches. The tray 14 can have a height h that ranges from between about 0.25 inches to about 12 inches. Desirably, the tray 14 has a height h which ranges from between about 0.3 inches to about 3 inches. Even more desirably, the tray 14 has a height h which ranges from between about 0.4 inches to about 2 inches. The upper surface 22 of the tray 14 can be flat, planar, curved or arcuate, or be irregular in profile. The upper surface 22 can be completely flat or have one or more indentations, cavities, depressions, channels, etc. extending downward therefrom. The upper surface 22 can also have one or more humps, bumps, protuberances, extensions, etc. extending upward therefrom. The one or more indentations, cavities, depressions, channels, etc. and/or the one or more humps, bumps, protuberances, extensions, etc. can function to influence the position, alignment and/or spatial orientation of each of the articles 12 on the tray 14. The primary functions of the indentations, cavities, depressions, channels, humps, bumps, protuberances and extensions is to limit the movement of each of the articles 12 and to orient or establish the position of each of the articles 12 on the tray 14. The indentations, cavities, depressions, channels, humps, protuberances and extensions limit the movement of the articles 12 in one or more directions. The articles 12 can be positioned and retained in a set orientation relative to the X-X, Y-Y and Z-Z axes.

The articles 12 can be spaced away from the lower surface 24 by any desired distance. Any single indentation, cavity, depression, channel, hump, bump, protuberance or extension can be designed to influence the position and specific orientation of one or more of the articles 12 such that their magnetic affinity is aligned in a predetermined direction. Likewise, multiple indentations, cavities, depressions, channels, humps, bumps, protuberances or extensions can be designed to influence the position and specific orientation of a single article 12.

The one or more indentations, cavities, depressions, channels, etc. and/or the one or more humps, bumps, protuberances, extensions, etc. can also immobilize each of the articles 12 in an orderly and organized manner. In FIG. 1, a semi-circular, elongated channel 26 is depicted formed in the upper surface 22 into which the handle of the hammer 16 is retained. The upper surface 22 also has a rectangular shaped cavity 28 for retaining the cylindrical pin 18, and a conical protuberance 30 for retaining the washer 20. The outer perimeter of the upper surface 22 can be of any desired geometrical shape. The lower surface 24 of the tray 14 is relatively flat or planar although it could be somewhat irregular, if desired. The lower surface 24 can also be slightly concave or convex. The lower surface 24 could also be textured, if desired. Desirably, the lower surface 24 is relatively flat so that it can rest against another flat surface. The outer perimeter of the lower surface 24 can be of any desired geometrical shape. The outer perimeter of the lower surface 24 can be identical, similar or different in size and/or shape from the outer periphery of the upper surface 22. The lower surface 24 is designed to contact and be magnetically attracted to a metal member. The metal member can be a stationary or movable member. The metal member should be at least partially constructed from a ferric or ferrous substance, such as a metal or steel, and have a magnetic affinity. The metal member can be anyone of various items including but not limited to: a metal storage cabinet; a steel cabinet, a metal appliance, such as a door or a side of a refrigerator; a tool box; a wheeled tool cart; a tool chest; a sliding drawer constructed from metal; a vehicle fender, outer body or bumper, such as the outer surface of a car, truck, van, bus, motorcycle, etc.; a metal post; a metal beam; etc.

Referring now to FIG. 2, the magnetic storage device 10 also includes a magnetic member 32. The magnetic member 32 can include one or more permanent magnets. The magnetic member 32 is also a 3-dimensional (3D) member that can vary in size, shape, type and kind. The magnetic member 32 can be a single magnet or a series of magnet segments. In FIG. 2, the magnetic member 32 is shown as a single, elongated magnet having a rectangular cross-sectional configuration. The magnetic member 32 is completely enclosed and embedded in the tray 14 and is positioned or aligned closer to the lower surface 24 than to the upper surface 22. However, the magnetic member 32 could be spaced an equal distance from the upper and lower surfaces, 22 and 24 respectively, or be positioned closer to the upper surface 22, if desired. Desirably, the magnetic member 32 is located closer to the lower surface 24 so that it exerts a sufficient magnetic affinity for attaching the magnetic storage device 10 to a metal member (not shown) when it is brought into close contact with the metal member. By attaching the lower surface 24 of the tray 14 to the metal member, the upper surface 22 and the articles 12 positioned thereon or therein will be readily accessible.

The magnetic member 32 can be fully enclosed in the tray 14 by forming the tray 14 from two or more sections. There are a variety of possible embodiments where two or more sections are used to enclose or surround the magnetic member 32. One way to visualize these embodiments is to picture a shell surrounding the magnetic member 32. The shell can be divided many different ways. For example, the shell can be divided into top and bottom members, left and right members, major and minor members, etc. The two or more sections can be assembled around the magnetic member 32 and fastened to one another in a variety of ways, including but not limited to: using a press fit, a snap fit, using molded-in-threads (helix threads), fasteners such as screws, pins, rivets, using solvent bonding, adhesive bonding, ultrasonic welding, vibration welding, spin welding, electromagnetic welding, induction welding, hot platen or hot plate welding, staking, brazing, soldering, crimping, sewing, etc.

Referring now to FIG. 3, an alternative embodiment of a magnetic storage device 10′ is depicted. In the magnetic storage device 10′, the magnetic member 32 is aligned flush with the lower surface 24 of the tray 14′ and exhibits an exposed surface 34. In other words, the magnetic member 32 is not completely embedded in the tray 14′. In this embodiment, the exposed surface 34 of the magnetic member 32 can be aligned flush with the lower surface 24, be slightly raised above the lower surface 24, or extend slightly below the lower surface 24. Desirably, the exposed surface 34 of the magnetic member 32 is aligned flush with the lower surface 24 of the tray 14′. This configuration will allow the lower surface 24 of the tray 14′ to be attached flush with a metal member, such as the fender on an automobile (not shown). There are various ways of fastening the magnetic member 32 to the tray 14′. For example, a recess 36 can be formed in the lower surface 24 of the tray 14′. The magnetic member 32 can be inserted or be positioned in the recess 36. Various mechanical fasteners or an adhesive can be used to secure the magnetic member 32 in the recess 36. For example, one could use a press fit, a snap fit, use an over molding technique, mold-in-threads (helix threads), use screws, pins, rivets, etc., use solvent bonding, adhesive bonding, ultrasonic welding, vibration welding, spin welding, electromagnetic welding, induction welding, hot platen or hot plate welding, staking, brazing, soldering, crimping, sewing or other means known to those skilled in the art.

Alternatively, the lower surface 24 of the tray 14′ can contain a recess 36 which surrounds the magnetic member 32 and a base (not shown) can be secured to the tray 14′ so as to enclose the recess 36.

Turning now to FIG. 4, one example of a magnetic member 32 is depicted. The magnetic member 32 can be a flexible magnet or a non-flexible magnet. The magnetic member 32 can have any desired geometrical configuration but for explanation purposes only, it will be described as an elongated strip of magnetic material having a longitudinal central axis X1-X1, a transverse central axis Y1-Y1, and a vertical central axis Z1-Z1. The magnetic member 32 has a length 1 measured parallel to the longitudinal central axis X1-X1. The length 1 of the magnetic member 32 can vary. When the magnetic member 32 is a single elongated strip, it should have a length 1 of at least about 1 inch, desirably, at least about 2 inches, and more desirably, at least about 3 inches. The length 1 of the magnetic member 32 can vary depending upon the size of the magnetic storage device 10 or 10′ that it is associated with. Normally, the length 1 of the magnetic member 32 will increase as the overall length of the magnetic storage device 10 or 10′ increases.

The magnetic member 32 also has a width w which can also vary. The width w of the magnetic member 32 can range from between about 0.1 inches to about 2 inches. Desirably, the width w of the magnetic member 32 ranges from between about 0.2 inches to about 1.5 inches. More desirably, the width w of the magnetic member 32 ranges from between about 0.3 inches to about 1.25 inches. Furthermore, the magnetic member 32 has a thickness t which can vary as well. The thickness t of the magnetic member 32 can range from between about 0.01 inches to about 0.5 inches. Desirably, the thickness t of the magnetic member 32 ranges from between about 0.05 inches to about 0.3 inches. More desirably, the thickness t of the magnetic member 32 ranges from between about 0.1 inches to about 0.25 inches.

The magnetic member 32 can be purchased from a variety of commercial vendors. One such company that sells magnets is Bunting Magnetic Company of Newton, Kans. The magnetic member 32 can be formed from any suitable magnet material, including ceramic, metallic and flexible magnetic materials. The magnetic member 32 can be a discrete ceramic or ferrite elements in a discoidal or substantially rectangular shape. Alternatively, the magnetic member 32 can be cut from a magnetic sheet into a smaller shape and size. Multiple smaller magnetic members can be cut to form a series of discrete magnets.

The magnetic member 32 can also be formed from a homogeneous material which is magnetized with one pole along one surface and an opposite pole along an opposite surface to form north-south regions. Likewise, the magnetic member 32 can be formed from a conventional flexible magnet of the sort having magnetizable barium ferrite particles dispersed in a rubbery matrix. Such materials are available from Arnold Engineering Company and RJF International Corporation. The magnetic member 32 can further be formed from a suitable powdered metallic material such as iron oxide.

The magnetic member 32 can be held in place in any suitable manner For example, the magnetic member 32 can be secured to the tray 14 or 14′ by glue, an adhesive, by an epoxy, by a silicone adhesive, by a cyanoacrylate adhesive, or by some other adhesive known to those skilled in the adhesive art. Alternatively, the magnetic member 32 could be inserted into the recess 36 and be held in place by a tight, friction or interference fit. Still further, the magnetic member 32 could be secured to the tray 14 or 14′ by a mechanical device or be secured using a tongue and groove structure.

The magnetic member 32 can produce a magnetic flux. The magnetic flux serves two purposes. First, the magnetic flux will attract and secure the lower surface 24 of the tray 14 or 14′ to a metal member (not shown). The magnetic flux is of sufficient force that the magnetic storage device 10 or 10′ will resist movement relative to the metal member. Second, the magnetic flux will hold each of the articles 12 in position adjacent to the upper surface 22 of the tray 14 or 14′, or in one of the indentations, cavities, depressions, channels, or on one of the humps, bumps, protuberances or extensions.

When the articles 12 are positioned or placed within one of the indentations, cavities, depressions, channels, or on one of the humps, bumps, protuberances, extensions, the user of the magnetic storage device 10 or 10′ will have to exert a slight force in order to remove each of the articles 12 from its original position. The magnetic flux insures that vibration, bumping or jarring of the magnetic storage device 10 or 10′ will not cause the articles 12 to dislodge from the respective indentations, cavities, depressions or channels, or from the humps, bumps, protuberances or extensions. The magnetic flux also assures that each of the articles 12 can be removed from the magnetic storage device 10 or 10′ without disturbing the position of the magnetic storage device 10 or 10′ relative to the metal member.

The magnetic flux is not so strong that it prevents or hinders a person, such as a mechanic, in removing and/or replacing an article 12 from and then back into the magnetic storage device 10 or 10′. Desirably, a person should be able to remove or replace an article 12 using only one hand. The magnetic storage device 10 or 10′ facilitates the utilization of a set of tools, i.e. socket wrench heads, especially when the mechanic is in an awkward position such that a one-handed operation is essential. Likewise, the magnetic flux is not so strong that it prevents or hinders a person from removing the magnetic storage device 10 or 10′ from the metal member.

The magnetic member 32 exerts a sufficient magnetic attraction on the articles 12 when each is positioned on the upper surface 22, or is placed in one of the indentations, cavities, depressions or channels, or is placed on one of the humps, bumps, protuberances or extensions. This magnetic attraction will temporarily retain the articles 12 therein. The magnetic member 32 exerts a sufficient magnetic attraction such that the articles 12 will be retained on the upper surface 22, or in one of the indentations, cavities, depressions or channels, or on one of the humps, bumps, protuberances or extensions. The articles 12 will be retained even when the magnetic storage device 10 or 10′ is placed at a steep angle, for example, at about 90 degrees to the ground or floor, or is inverted (turned upside down).

As stated above, the magnetic member 32 also simultaneously exerts a sufficient magnetic flux or attraction through the lower surface 24 or through its exposed surface 34 to releasably attach the magnetic storage device 10 or 10′ to a metal member. The magnetic member 32 will secure the magnetic storage device 10 or 10′ to any ferrous metallic surface, such as a metallic work bench or shelf, a motor vehicle, or any other suitable location. For example, the magnetic storage device 10 or 10′ can be used by a mechanic working in the engine compartment of a motor vehicle. The magnetic storage device 10 or 10′ can be magnetically attached to any portion of the metal surface of the vehicle. The orientation of the magnetic storage device 10 or 10′ is not important since it can be attached to a metal surface of the vehicle even while inverted or on its side. The placement of the magnetic storage device 10 or 10′ close to the area being worked on increases the efficiency of the mechanic and generally makes the job a lot easier.

There may also be times when a mechanic does not know the exact diameter of a particular socket wrench head which is needed to fit onto the head of a bolt, which is to be removed or tightened. In this situation, the mechanic will try to match up a socket wrench head to test the size of the bolt. The mechanic may have to try two or three socket wrench heads before he finds the correct diameter. Having the magnetic storage device 10 or 10′ located adjacent to his work area will make this whole process quicker and more efficient. The mechanic will not be required to reach for another socket wrench head which may be located several feet away.

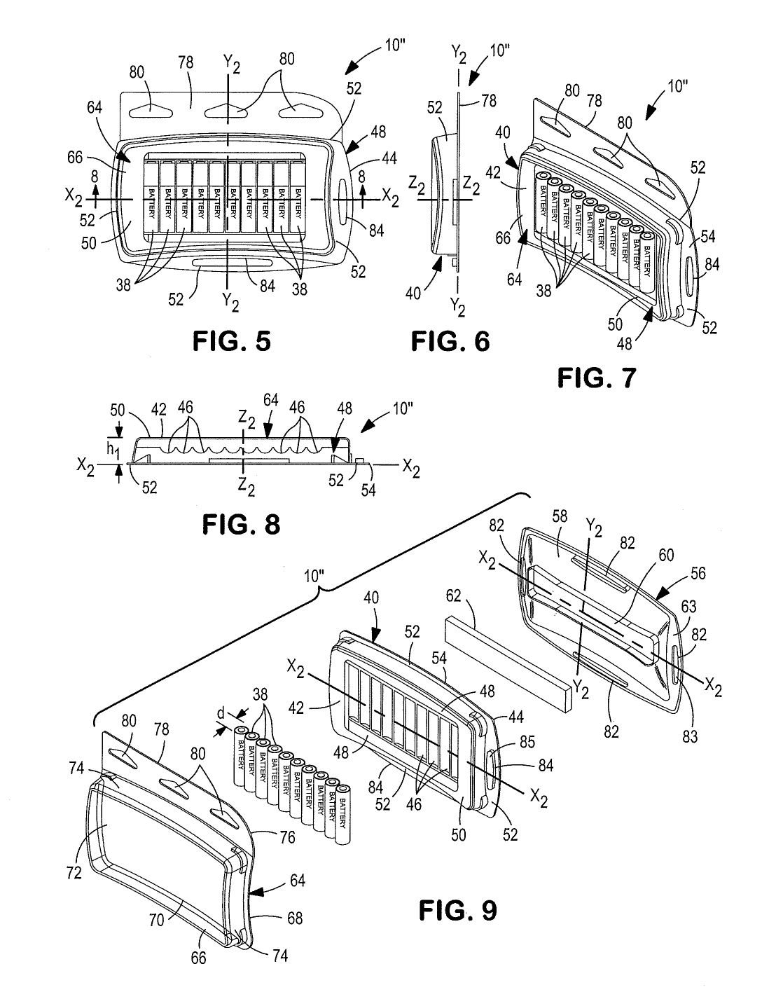

Referring now to FIGS. 5-9, another embodiment of a magnetic storage device 10″ is depicted. This magnetic storage device 10″ is specifically designed to house and retain a plurality of batteries 38. However, the magnetic storage device 10″ could retain or house different articles 12 as well. The batteries 38 are depicted as all being of the same size. However, two or more different size batteries 38 could be retained or housed in the magnetic storage device 10′, if desired. The exact number of batteries 38 retained in the magnetic storage device 10″ can vary from 1 to about 50 or more. In FIGS. 5-7, ten batteries 38 are shown and each is of the same size. The batteries 38 can vary in actual size. For example, the batteries can be AAA, AA, A, C, D, or any other size that is commercially manufactured.

The magnetic storage device 10″ has a longitudinal central axis X2-X2, a transverse central axis Y2-Y2, and a vertical central axis Z2-Z2. The magnetic storage device 10″ includes a three dimensional (3D) tray 40 having an upper surface 42, a lower surface 44 and a height h1 therebetween. The tray 40 has one or more cavities 46 formed therein. Desirably, the tray 40 has two or more cavities 46 formed therein. More desirably, the tray 40 has a plurality of cavities 46 formed therein. Ten cavities are depicted in FIG. 5, with each cavity 46 being sized and configured to receive at least a portion of a battery 38. Each battery 38 has a thickness or diameter d, see FIG. 9. As mentioned above, the battery 38 could be any other article having a predetermined thickness. If the battery 38 does not have an elongated, cylindrical shape with a measurable diameter, then the thickness of the battery 38 can be used. For example, a smoke detector uses a rectangular shaped battery having a thickness of about ⅜ of an inch.

The plurality of cavities 46 formed in the tray 40 can be of any desired geometrical shape. As depicted, each of the plurality of cavities 46 has an elongated, semi-circular configuration with opposite ends. Multiple cavities 46 form an undulating surface having a scallop appearance. The opposite ends of each of the plurality of cavities 46 can be at least partially surrounded by a pair of raised abutments 48, 48. The pair of raised abutments 48, 48 is shown being located at opposite ends of each of the semicircular cavities 46. Alternatively, one could utilize a single raised abutment 48 which is located at one end of each of the semi-circular cavities 46.

The pair of raised abutments 48, 48 are spaced apart and aligned parallel to one another. Each of the pair of raised abutments 48, 48 is located adjacent to an end of each of the plurality of cavities 46. Each of the pair of raised abutments 48, 48 has an upper surface 50, 50. The upper surface 50 of each of the pair of raised abutments 48, 48 can vary in configuration. For example, the upper surface 50 can be planar, concave, convex, irregular, curved, etc. The upper surface 50 can also vary in height along its length. Desirably, the height of the upper surface 50, 50 will be constant throughout their lengths. The upper surface 50 of each of the pair of raised abutments 48, 48 is located below the upper surface 42 of the tray 40. The upper surface 50 of each of the pair of abutments 48, 48 is positioned above the lowest point of each of the plurality of cavities 46. The upper surface 50 of each of the pair of abutments 48, 48 extends upward to a height that is less than half of the thickness or diameter of one of the batteries 38 positioned in one of the plurality of cavities 46.

The upper surface 50 of each of the pair of abutments 48, 48 can have a height that intersects the thickness or diameter of each of the batteries 38 such that from about 1% to about 50% of the thickness or diameter of each battery 38 is at or below the upper surface 50. Another way of stating this is to say that less than about 50% of the thickness or diameter of each battery 38 is positioned in one of the plurality of cavities 46. Desirably, less than about 45% of the thickness or diameter of each battery 38 is positioned in one of the plurality of cavities 46. More desirably, less than about 40% of the thickness or diameter of each battery 38 is positioned in one of the plurality of cavities 46. Even more desirably, less than about 35% of the thickness or diameter of each battery 38 is positioned in one of the plurality of cavities 46. Most desirably, less than about 30% of the thickness or diameter of each battery 38 is positioned in one of the plurality of cavities 46. The reason for this size difference is to allow a person to easily retrieve a battery 38 from the tray 40. By limiting the height of the pair of abutments 48, 48, one can quickly and readily remove each of the batteries 38 from their respective cavities 46 or return a battery to a cavity 46.

The magnetic storage device 10″ further includes a nesting, overlapping or locking feature which enables one magnetic storage device 10″ to be positioned adjacent to or be conterminously aligned with another like magnetic storage device 10″. This feature can be accomplished several ways. One way is to construct the tray 40 with a flange 52. The flange 52 terminates into an outer periphery 54. The flange 52 can extend horizontally outward to the outer periphery 54, see FIG. 8. The flange 52 can extend outward from a portion of the tray 40 or from the entire tray 40. In other words, the flange 52 can extend outward a full 360 degrees or only extend outward a portion thereof.

In FIG. 5, the flange 52 extends outward beyond the entire upper surface 42 of the tray 40. The length or extent that the flange 52 extends outward from the outline of the upper surface 42 of the tray 40 can vary. Alternatively, the length or extent that the flange 52 extends outward from the outline of the upper surface 42 of the tray 40 can be a constant.

In other words, the flange 52 would extend outward the same amount from all points of the outline of the upper surface 42 of the tray 40. In FIG. 5, the flange 52 extends outward from the right side and the bottom of the outline of the upper surface 42 of the tray 40 to a greater extent than it does on the left side. However, one can choose in what direction one wishes the flange 52 to extend outward from the outline of the upper surface 42 of the tray 40. The flange 52 can extend outward from the entire outline of the upper surface 42 of the tray 40 an equal amount. Likewise, one can manufacture the tray 40 such that the flange 52 extends outward different amounts from the various sides of the tray 40. The size, shape, and/or geometrical configuration of the flange 52 can also vary. Furthermore, the flange 52 can vary in thickness. The thickness of the flange 52 is measured parallel to the vertical central axis Z2-Z2.

The amount the flange 52 extends outward from the outer periphery 54 of the tray 40 can vary from between about 0.05 inches to about 1 inch or more. Desirably, the flange 52 extends outward from the outline of the upper surface 42 of the tray 40 from between about 0.1 inches to about 0.75 inches. The flange 52 can extend outward parallel to the longitudinal central axis X2-X2 and/or parallel to the transverse central axis Y2-Y2

Referring now to FIG. 9, the magnetic storage device 10″ also includes a base 56 having an upper surface 58 and a cavity 60 formed in the upper surface 58. The upper surface 58 can be contoured, if desired. The upper surface 58 of the base 56 is sized and configured to mate or nest with the lower surface 44 of the tray 40. Alternatively, the base 56 can be sized and configured so that it can be adhesively bonded, mechanically attached, secured by an interference fit, a friction fit, or otherwise be secured to the tray 40 by means known to those skilled in the art.

The cavity 60 formed in the base 56 can vary in size; shape and location. Desirably, the cavity 60 is an elongated opening that extends downwardly from the upper surface 58 and has a longitudinal axis which is aligned parallel with the longitudinal central axis X2-X2. The cavity 60 is designed to receive, partially or fully, a magnetic member 62. The magnetic member 62 can be similar to the magnetic member 32, explained above with reference to FIG. 4. The magnetic member 62 will be sandwiched between the tray 40 and the base 56 when these two members are secured together. The cavity 60 prevents the magnetic member 62 from appreciably moving in any direction a considerable amount. The magnetic member 62 exerts a sufficient magnetic attraction through the base 56 to releasably attach the magnetic storage device 10″ to a magnetically attractive surface. The upper surface 58 of the base 56 can include a flange 63. The flange 63 can be sized and configured to match the flange 52 formed on the tray 40. The flange 63 should extend horizontally outward from the base 56.

The magnetic storage device 10″ can further include a cover 64 which is sized and configured to fit over the tray 40 and can rest against the upper surface 58 of the base 56. The cover 64 can be constructed from a clear or transparent material, such as clear plastic, so that the articles 12 positioned on the tray 40 are visible to the naked eye. The cover 64 can be constructed so that it can be completely removed from the tray 40, as depicted in FIG. 9, or it can be secured to the tray 40 by one or more hinges (not shown). In either embodiment, the cover 64 should allow easy access to the batteries 38 housed on the tray 40.

The cover 64 has an upper surface 66 and a lower surface 68. The cover 64 also has a hollow cavity 70 which is open to the lower surface 68. The hollow cavity 70 is sized and configured to fit over the tray 40 and contact the flange 52. Desirably, the hollow cavity 70 is sized and configured to mate with at least a portion of the outer periphery 54 of the tray 40. The upper surface 66 of the cover 64 forms a plateau 72 having sidewalls 74. Four sidewalls 74, 74, 74 and 74 are present in FIG. 9 although only two of the sidewalls 74, 74 are visible in this view. It should be understood that if the cover 64 was formed with a circular configuration, than it would have one continuous sidewall 74. If the cover 64 was formed with a triangular configuration, than it would have three sidewalls 74, 74 and 74.

The four sidewalls 74, 74, 74 and 74 extend downward a desired amount and terminate at a flange 76. The flange 76 can vary in size and shape. The amount the flange 76 extends horizontally outward from one or more of the sidewalls 74, 74, 74 and 74 can also vary. Typically, the amount that the flange 76 can extend outward from at least one of the sidewalls 74, 74, 74 and 74 will range from between about 0.1 inches to about 6 inches or more. In the embodiment shown in FIG. 9, the portion of the flange 76 extends upwards from the top edge of the plateau 72 and has a greater dimension than the portions which extend outward from the left, right and bottom edges of the cover 64. However, one can size and shape the flange 76 to any desired dimension and configuration.

In FIG. 9, the portion of the flange 76 that extends upwards from the top edge of the plateau 72 includes a printable surface 78. The printable surface 78 can be formed from paper, paper board, cardboard or some other material on which one can print or write. For example, the printable surface 78 can be an adhesive backed paper that is secured to a portion of the flange 76. The printable surface allows information and/or advertisements about the batteries 38, which are retained in the magnetic storage device 10″, to be displayed. Such information can include but is not limited to: the price of the batteries 38, the name of the batteries 38, the manufacturer of the batteries, the size of the batteries 38, the life of the batteries 38, etc.

Referring to FIGS. 5, 7 and 9, one or more openings 80 can be formed in the flange 76. The openings 80 are spaced apart from one another and function as a means for supporting the magnetic storage device 10″ on one or more horizontal hooks (not shown) normally found in a retail outlet. The horizontal hooks provide an efficient way to mount a plurality of the magnetic storage devices 10″ adjacent to one another and in a compact fashion on vertical peg board at a retail store. Such an arrangement allows consumers to readily view the batteries 38 and remove one or more of the magnetic storage devices 10″ when they are ready to purchase the packages.

Referring again to FIG. 9, the magnetic storage device 10″ further includes a first attachment mechanism 82 formed on the flange 63 of the base 56. The first attachment mechanism 82 can vary in size, shape and configuration. The first attachment mechanism 82 is shown as a hollow protuberance which projects upward from the flange 63. The first attachment mechanism 82 has a closed top surface 83 and an open bottom surface (not visible in FIG. 9). Four of the first attachment mechanisms 82 are depicted, with one aligned adjacent to the right side, left side, top side and bottom side of the base 56. It should be understood that one or more of the first attachment mechanisms 82 can be present on the base 56.

The magnetic storage device 10″ also includes a second attachment mechanism 84 formed on the flange 52 of the tray 40. The second attachment mechanism 84 can vary in size, shape and configuration but has to be sized, shaped and configured to mate with one of the first attachment mechanisms 82. The second attachment mechanism 84 is shown as a hollow protuberance which projects upward from the flange 52. The second attachment mechanism 84 has a closed top surface 85 and an open bottom surface (not visible in FIG. 9). The upwardly extending protuberance of the first attachment mechanism 82 is sized and configured to mate or nest with the open bottom surface of the second attachment mechanism 84. Two of the second attachment mechanisms 84, 84 are shown in FIGS. 5 and 9. However, it should be understood that one or more of the second attachment mechanisms 84 can be present on the tray 40. Each of the second attachment mechanisms 84 is sized and shaped to mate or nest with one of the first attachment mechanisms 82, 82, 82 and 82. The interaction between the first and second attachment mechanisms, 82 and 84 respectively, function to secure the tray 40 to the base 56. Desirably, a friction fit is established between the connection of the first and second attachment mechanisms, 82 and 84 respectively.

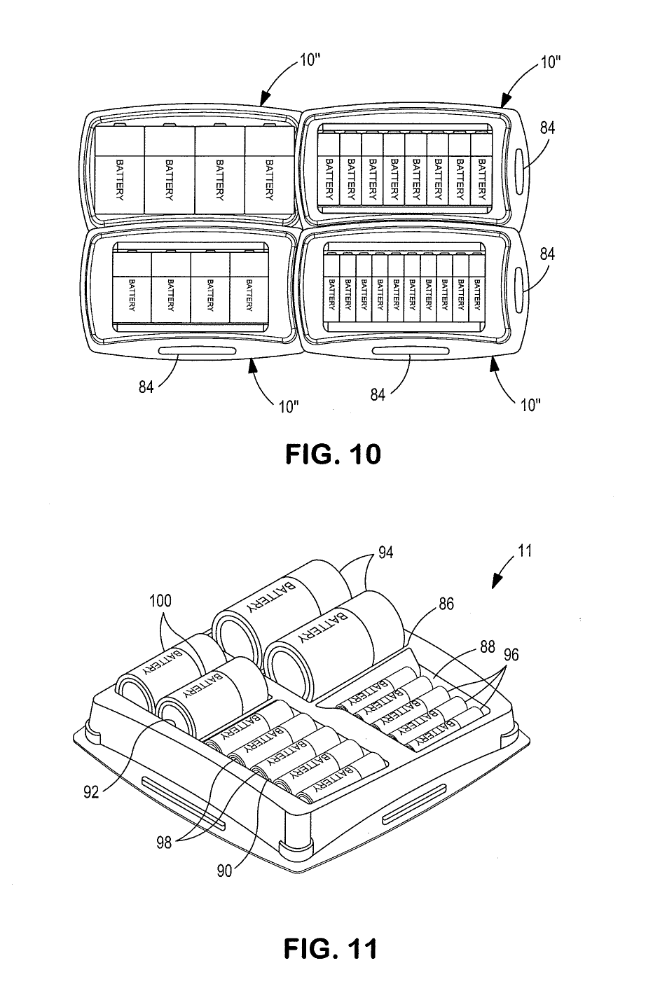

Referring now to FIGS. 9 and 10, each of the second attachment mechanisms 84, 84 serves two functions. The first function occurs when the first and second attachment mechanisms, 82 and 84 respectively, are mated or nested together, in that the second attachment mechanisms 84, 84 provide a means for securing the tray 40 to the base 56. This connection can result in a friction fit, an interlocking fit, an interference fit, etc. The mating of the first and second attachment mechanisms, 82 and 84 respectively, should form a secure fit such that the tray 40 and the base 56 will not easily separate from one another. The second function served by each of the second attachment mechanisms 84 is that each provides a means for attaching or securing a second magnetic storage device 10″ to the magnetic storage device 10″.

Still referring to FIG. 10, four magnetic storage devices 10″ are shown which are assembled together. Each of the second attachment mechanisms 84 provides a way to secure one magnetic storage devices 10″ to another magnetic storage device 10″. Sometimes, it is desirable to group two or more of the magnetic storage devices 10″ together. If a magnetic storage device 10″ contains AAA size batteries 38, and a second magnetic storage device 10″ contains AA size batteries 38, and a third magnetic storage device 10″ contains A size batteries 38, then a consumer can group all three magnetic storage devices 10″, 10″ and 10″ together. When the consumer is in need of a particular size battery 38, he or she can go to one location to retrieve the correct size battery 38. The ability to mesh, overlap or connect two or more of the magnetic storage devices 10″, 10″ enhances the ability of a manufacturer to get a consumer to purchase more than one package of their articles. This can produce increased sales which will hopefully lead to increased profits.

Although one specific way to connect or mesh two or more magnetic storage devices 10″, 10″ has been described above by using the second attachment mechanisms 84, one skilled in the art will understand that a variety of ways exist to connect or interlock two or more of the magnetic storage devices 10″, 10″ together. For example, one can fit, mesh or connect two or more of the magnetic storage devices 10″, 10″ together using mechanical connections. Two or more of the magnetic storage devices 10″, 10″ can be mated together by using press fits, such as a plug engaging a hollow socket; a snap fit; an interference fit, such as a ball and socket arrangement; an overlapping mechanism, such as a pintle and hook, a plug and yoke; as well as intermeshing mechanisms, such as puzzle piece connections, male and female threads, etc. Furthermore, one can insert or position a magnet in the tray 40 or base 56 portion of a magnetic storage device 10″ such that it will magnetically be attracted to another magnetic storage device 10″. Those skilled in the fastening or mating art will be aware of still other ways to provide an association between two or more of the magnetic storage devices 10″, 10″.

Referring now to FIG. 11, a magnetic storage device 11 is shown which is capable of retaining different size articles 12. The articles 12 are depicted as four different size batteries. The magnetic storage device 11 contains two or more cavities 86, 88, 90 and 92 of four different sizes. In this embodiment, there are two of the cavities 86, 86 which are sized and shaped to hold two D size batteries 94; there are five of the cavities 88, 88, 88, 88 and 88 which are sized and shaped to hold five AAA size batteries 96, 96, 96, 96 and 96; there are five cavities 90, 90, 90, 90 and 90 which are sized and shaped to hold five AA size batteries 98, 98, 98, 98 and 98; and two of the cavities 92, 92 which are sized and shaped to hold two C size batteries 100, 100. It should be understood that the number, size and shape of the cavities 86, 88, 90 and 92 can vary to accommodate the number, size and shape of the articles 12 one wished to retain in the magnetic storage device 11.

Method of Assembling

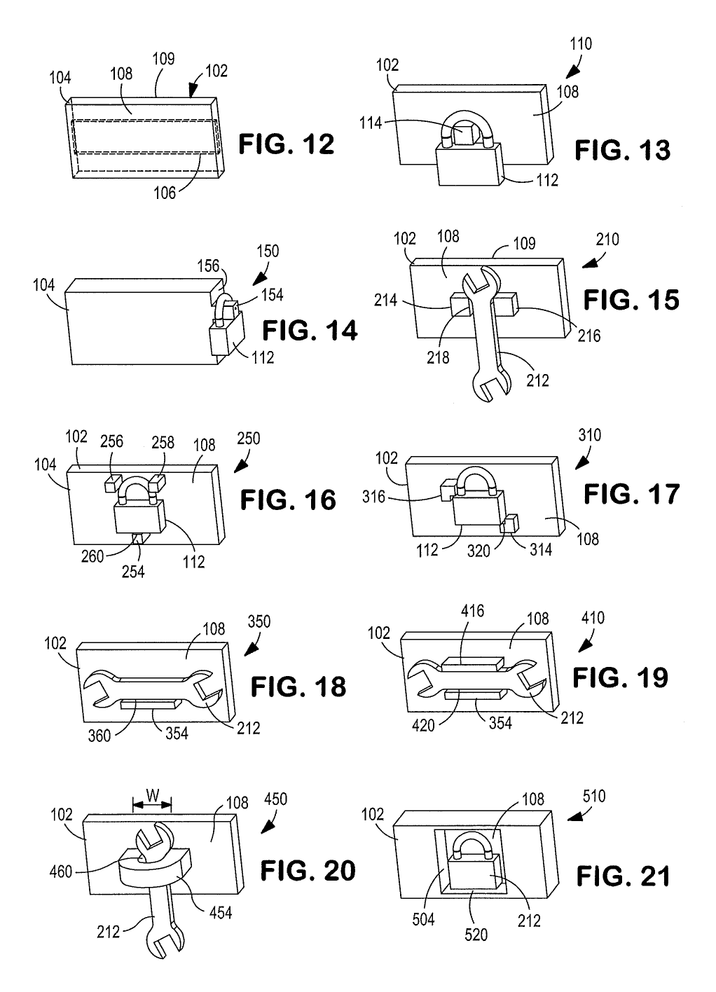

With reference to FIG. 12, a method of assembling a magnetic storage device 10″ which is capable of retaining a plurality of articles 12, each having a thickness and a magnetic affinity, will now be explained. The method of assembling a magnetic storage device 10″ includes the steps of forming a base 56. The base 56 has an upper surface 58 with a cavity 60 formed in the upper surface 58. The cavity 60 extends downward from the upper surface 58. The method also includes forming a tray 40 having an upper surface 42, a lower surface 44, and a height h therebetween. The lower surface 44 is sized and configured to mate with the upper surface 58 of the base 56. The upper surface 42 of the tray 40 has a plurality of cavities 46 formed therein. Each of the plurality of cavities 46 has an elongated, semi-circular configuration with opposite ends. A pair of raised abutments 48, 48 is aligned adjacent to the opposite ends of each of the plurality of cavities 46. Each of the pair of raised abutments 48, 48 has an upper surface 50 which is located below the upper surface 42 of the tray 40. Each of the upper surfaces 50, 50 of the pair of abutments 48, 48 extends upward to a height that is less than the thickness of one of the plurality of articles 12 when at least one of the plurality of articles 12 is positioned in one of the plurality of cavities 46. The method further includes positioning a magnetic member 62 in the cavity 60 formed in the upper surface 58 of the base 56. The base 56 is then mated with the tray 40 such that the lower surface 44 of the tray 40 engages the upper surface 58 of the base 56. An article 12 is placed or positioned in each of the plurality of cavities 46 formed in the upper surface 42 of the tray 40.

In addition, the method can further include securing a removable cover 64 onto the tray 40 so that the articles 12 are enclosed between the cover 64 and the tray 40. The cover 64 is preferably constructed from a transparent material, such as plastic, so that one can see through the cover 64 and identify the articles 12 positioned on the tray 40.

A flange 52, 63, 76 can be formed on each of the tray 40, the base 56 and the cover 64, respectively. In addition, a first attachment mechanism 82 can be formed on the flange 63 of the base 56 and a second attachment mechanism 84 can be formed on the flange 52 of the tray 40. The first and second attachment mechanisms, 82 and 84 respectively, are capable of securing the tray 40 to the base 56. In addition, the second attachment mechanism 84 provides a means for securing a second magnetic storage device 10″ to the magnetic storage device 10″.

The method can further include securing a third magnetic storage device 10″ to the second magnetic storage device 10″ or securing the third magnetic storage device 10″ to the initial magnetic storage device 10″. Furthermore, the method can also include securing a fourth magnetic storage device 10″ to one of the other second magnetic storage devices 10″. Multiple magnetic storage devices 10″, 10″, etc. can be grouped or attached in this manner.

Lastly, the method can further include forming or attaching a printable surface 78 onto the flange 76 of the cover 64. The printable surface 78 can be in the form of an adhesive backed paper 78. The adhesive side is to secure the paper to the flange 76. The printable surface 78 should allow one to write, print, type, etc. one or more words, numbers, symbols, photos, images, etc. thereon. The information presented on the printable surface 78 can relate to the plurality of batteries 38 retained in the magnetic storage device 10″.

### Additional Embodiments

FIGS. 12-29 illustrate variations of the magnetic storage device 10 which is shown in FIG. 1. FIG. 12 illustrates a base unit 102 serving as a foundation for the magnetic storage devices shown in FIGS. 13-29. The base unit 102 includes a back 104 and a magnet 106. The back 104 contains and holds the magnet 106. In one implementation, the back 104 includes a two-piece assembly including a base and a tray, wherein the base and tray are welded, fastened, snapped or otherwise joined to one another with the magnet 106 therebetween. In another implementation, the back 104 may include a body having an opening into which the magnet 106 is inserted. In the example illustrated, the back 104 has a front face 108 and a rear face 109. The rear face 109 is configured to be supported against a vertical plane or wall, either through use of the magnet 106 or through use of a hang hole, hanger, fastener or other mounting mechanism.

The magnet 106 includes an elongate magnetic strip, bar or band position within the back 104. In some implementations, the magnet 106 may be supported or be mounted along the back face 109 of the back 104. The magnet 106 has a sufficient magnetic strength so as to magnetically attract and releasably hold articles supported along the back 104.

Referring to FIG. 13, a magnetic storage device 110 is illustrated. The magnetic storage device 110 includes a base unit 102 (described above) and a protuberance 114. The protuberance 114 includes a projection or other structure extending from the front face 108 so as to engage a portion of an article 112 having a magnetic affinity. In FIG. 13, the protuberance 114 includes a post which is encircled by a portion of the article 112 such that the article 112 hangs from the protuberance 114. The protuberance 114 is configured such that the article 112 is held, but is still free to rotate about an axis aligned parallel to the front face 108. Resistance to rotation of the article 112 is provided by the magnet 106 see FIG. 12. As a result, the magnet 106 not only assists in retaining the article 112 on the protuberance 114, to prevent accidental dislodgement of the article 112 from the protuberance 114, but also further inhibits rotation of the article 112 about a horizontal axis, thereby inhibiting accidental dislodgement of the article 112. Although the protuberance 114 is illustrated as having a square cross-sectional shape, in other implementations, the protuberance 114 may have other cross-sectional shapes and configurations. For example, the protuberance 14 may have a circular, rectangular or some other shape. In some implementations, the protuberance 114 may include a hook.

Referring now to FIG. 14, a magnetic storage device 150 is illustrated, which is another implementation of the magnetic storage device 110. The magnetic storage device 150 is similar to the magnetic storage device 110 except that the magnetic storage device 150 includes a protuberance 154 which extends from a side face 156 of the back 104. As shown in FIG. 14, the protuberance 154 holds the article 112 (shown as a padlock) such that the article 112 is free to rotate about an axis parallel to the front face 108 except for resistance against such rotation provided by the magnet 106, see FIG. 12.

Referring now to FIG. 15, a magnetic storage device 210 is illustrated. The magnetic storage device 210 includes a base unit 102 and two protuberances 214, 216. The two protuberances 214, 216 project outward from front face 108 at spaced apart locations along the front face 108 to form a recess 218. The recess 218 is configured to receive an article 212 (shown as a wrench) such that the article 212 may hang from the two protuberances 214, 216. The article 212 is free to rotate about an axis aligned parallel to the front face 108 except for the resistance against such rotation provided by the magnet 106. In FIG. 15, the article 212 rests upon an upper surface of each of the two protuberances 214 and 216. The article 212 also extends vertically above and below the two protuberances 214 and 216. The article 212 is supported such that it may freely rotate about an axis aligned perpendicular to the front face 108 except for releasable resistance provided by the magnetic forces of the magnetic 106. Although the two protuberances 214 and 216 are illustrated as having rectangular cross-sectional shapes, in other implementations, the two protuberances 214 and 216 may have other cross-sectional shapes and configurations.

Referring now to FIG. 16, a magnetic storage device 250 is illustrated. The magnetic storage device 250 includes a base unit 102 and three protuberances 254, 256 and 258. The three protuberances 254, 256 and 258 extend outward from the base 108 and are configured to hold an article 112 (shown as a padlock) such that the article 112 is free to rotate about an axis aligned parallel to the front face 108 except for resistance against such rotation provided by the magnet 106 (shown in FIG. 12). In particular, one or more of the three protuberances 254, 256 and 258 are sufficiently flexible to allow the article 112 to be manually rotated about an axis aligned parallel to the front face 108 without dislodgement of the article 112. Accidental dislodgement of the article 112 is prevented by the magnetic forces of the magnet 106 which are exerted upon portions of the article 112 having a magnetic affinity. In FIG. 16, the protuberance 254 forms a ledge 260 which underlies a portion of the article 112. The other two protuberances 256, 258 are located above the protuberance 254 and engage opposite side portions of the article 112 to hold the article 112. Because the three protuberances 254, 256 and 258 are spaced apart from one another and merely engage particular portions of the article 112 about a periphery of the article 112 (rather than continuously engaging the entire periphery of the article 112 adjacent to the base 104), a greater extent of the article 112 may be viewed and inspected when stored or when presented for retail sale. In other implementations, the protuberances 254, 256 and 258 may have other configurations and may be configured to similarly hold and retain other articles other than the padlock shown. Furthermore, additional protuberances may be provided for holding the article 112.

Referring now to FIG. 17, a magnetic storage device 310 is illustrated. The magnetic storage device 310 includes a base unit 102 and two protuberances 314, 316. The two protuberances 314, 316 include projections extending from the front face 108 so as to hold article 112 (shown as a padlock). The article 112 is free to rotate about an axis aligned parallel to the front face 108 except for resistance against such rotation provided by the magnet 106. In FIG. 17, the two projections 314, 316 are rubberlike or sufficiently flexible such as to permit the article 112 to be manually rotated about an axis aligned parallel to the front face 108. In FIG. 17, the two protuberances 314 and 316 engage opposite comers of the article 112. This allows for visual inspection of a greater extent of the article 112. In FIG. 17, the protuberance 314 forms a ledge 320 or upwardly facing shoulder upon which the article 112 may rest. In other implementations, the two protuberances 314 and 316 may have other configurations and may be configured to similarly hold and retain other articles other than the padlock shown. Furthermore, additional protuberances may be provided for holding the article 112.

Referring now to FIG. 18, a magnetic storage device 350 is illustrated. The magnetic storage device 350 includes a base unit 102 and a protuberance 354. The protuberance 354 includes a ledge 360 underlying and supporting the article 212 (shown as a wrench that is completely formed from a material having magnetic affinity or includes portions that have a magnetic affinity, i.e. a ferrous material). The ledge 360 merely engages an underside of the article 212, permitting a greater extent of the article 212 to be visually inspected while being supported. The protuberance 354 holds the article 212 such that the article 212 is free to rotate about an axis aligned parallel to the front face 108 except for magnetic resistance against such rotation provided by the magnet 106. The magnet 106 exerts a magnetic force inhibiting rotation of the article 212 about a horizontal axis away from the front face 108 and off of ledge 360. In other implementations, the protuberance 354 may have other configurations and may be configured to similarly hold and retain other articles other than the wrench shown. Furthermore, additional protuberances may be provided for holding the article 212.

Referring now to FIG. 19, a magnetic storage device 410 is illustrated. The magnetic storage device 410 includes a base unit 102 and two protuberances 354 and 416. The two protuberances 354 and 416 project out from the front face 108. The protuberance 416 is located opposite to the projection 354 and is spaced apart from the projection 354 so as to form a horizontal channel 420 which receives the article 212 (shown as a wrench). In FIG. 19, the channel 420 is sufficiently large or wide so as to permit the article 212 to pivot or rotate about a horizontal axis aligned parallel to the front face 108. In other implementations, the two protuberances 354 and 416 may provide a friction fit with the article 212, wherein the article 212 is removed by pulling the article 212 along an axis aligned perpendicular to the front face 108, against the friction force of the two protuberances 354, 416 and against the magnetic force of magnet 106. Although the magnetic storage device 410 is illustrated as including two spaced protuberances 354 and 416, in other implementations, the magnetic storage device 410 may include a greater number of upper or lower spaced protuberances. Although the two protuberances 354 and 416 are illustrated as rectangular bars, in other implementations, the protuberances 354 and 416 may have other shapes and sizes depending upon the article to be held.

Referring now to FIG. 20, a magnetic storage device 450 is illustrated. The magnetic storage device 450 includes a base unit 102 and a protuberance 454. The protuberance 454 includes a projection configured to hold the article 212 (shown as a wrench) such that article 212 is free to rotate about an axis aligned parallel to front face 108 except for resistance provided by magnetic forces against such rotation provided by the magnet 106 (shown in FIG. 12). In FIG. 20, the protuberance 454 includes a ring or some other shape forming an asymmetric opening 460 from which the article 212 may hang when the article 212 is in a first orientation with respect to a vertical axis. In this position, portions of the article 212 located above the opening 460 are wider than the size of the opening in a direction parallel to the front face 108 and through which the article 212 may be withdrawn when the article 212 is in a second orientation with respect to the vertical axis. In FIG. 20, the article 212 has a width W which is wider than the width of the opening 460. The width W extends in a direction parallel to the front face 108 and is less than a length of the opening 460 which extends in a direction perpendicular to the front face 108. In operation, the magnet 106 applies a magnetic force to bias the article 212 towards the first orientation such that the width of the article 212 extends in a direction aligned parallel to the front face 108 so as to retain the article 212 in an orientation such that the article 212 hangs and cannot be withdrawn without first rotating the article 212 about a vertical axis and against the bias force provided by the magnet 106. In other implementations, the opening 460 may have other shapes and sizes depending on the shape of the article 212 to be held by the magnetic storage device 450.

Referring now to FIG. 20, a magnetic storage device 510 is illustrated. The magnetic storage device 510 includes a base unit 102 and a cove 504. The cove 504 extends into the back 104 and provides a ledge 520 upon which the article 212 may rest while the base unit 102 is in a vertical orientation. The protuberance forming ledge 520 permits the article 212 to freely rotate about an axis aligned parallel to the front face 108 except for magnetic resistance against such rotation provided by the magnet 106 (shown in FIG. 12) which extends behind the front face 108. The free positioning of the article 212 in the back 104 provides greater visual inspection of the article 212 and also permits the article 212 to be withdrawn by a user. However, accidental removal or dislodgement of the article 212 is inhibited by the magnet 106.

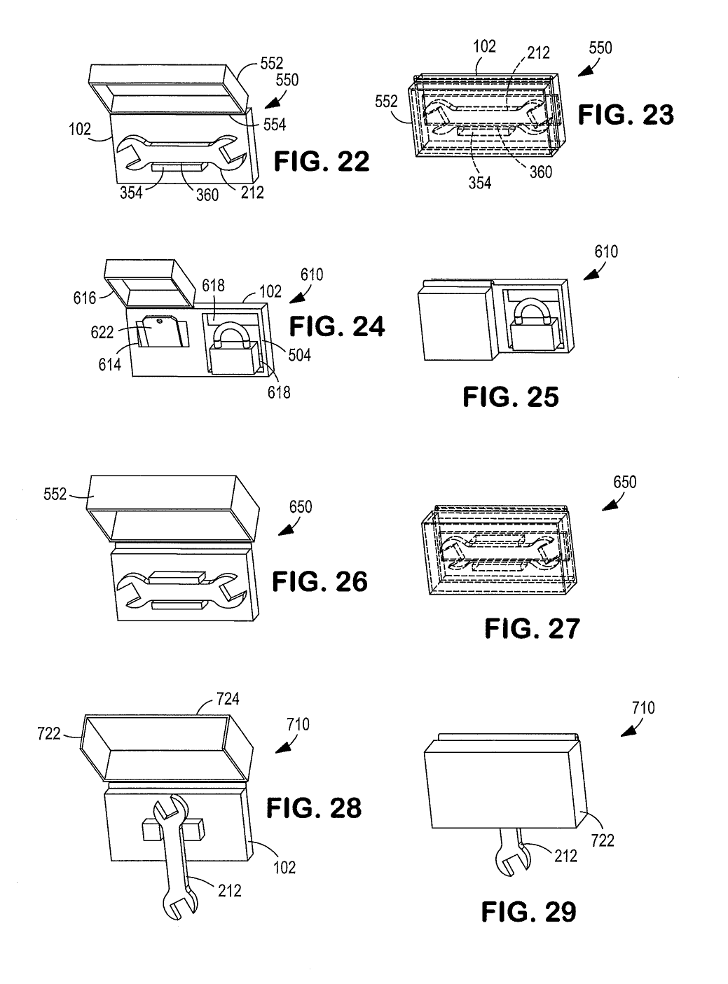

Referring now to FIG. 22-29 additional variations of magnetic storage devices is depicted. In FIG. 22, a magnetic storage device 550 is illustrated in an open state. The magnetic storage device 550 is identical to the magnetic storage device 350, except that the magnetic storage device 550 additionally includes a cover 552. In FIG. 22, the cover 552 is pivotably coupled to the base unit 102 by a hinge 554. The hinge 554 may be a living hinge, wherein the cover 552 is integrally formed as part of the base unit 102 or may include a mechanical hinge.

Referring now to FIG. 23, the magnetic storage device 550 is shown in a closed state. When closed, the cover 552 surrounds and encloses the article 212 while the magnet 106 retains the article 212 on the ledge 360. In one implementation, the cover 552 is translucent or transparent, allowing visible inspection of the article 212 while the cover 552 is closed.

Referring now to FIG. 24, a magnetic storage device 610 is illustrated. The magnetic storage device 610 is similar to the magnetic storage device 510 except that the magnetic storage device 610 additionally includes a slot 614 and a cover 616. The magnetic storage device 610 further includes an opening 618 formed through the back 104, behind the cove 504. The slot 614 includes a chamber, cavity or opening extending into the back 104 so as to receive an additional article 622. In FIG. 24, the article 622 includes an article that does not have magnetic affinity. In FIG. 24, the article 62 is a card which may be dropped into the slot 614. In other implementations, the slot 614 may have other configurations depending upon the configuration of the article 622.

Referring now to both FIGS. 24 and 25, the magnetic storage device 610 also includes a cover 616. The cover 616 is pivotally coupled to the back 104. The cover 616 is spaced away from the slot 614 when in an open state, see FIG. 24. When the cover 616 is open, access to the article 622 is permitted and the article 622 can be withdrawn. In the closed state, the cover 616 surrounds and encloses the slot 614, see FIG. 25. In other implementations, the cover 616 may be omitted.

Referring now to FIGS. 26 and 27, a magnetic storage device 650 is illustrated. The magnetic storage device 650 is similar to the magnetic storage device 410 except that it includes a cover 552.

Referring now to FIGS. 28 and 29, a magnetic storage device 710 is illustrated. The magnetic storage device 710 is similar to the magnetic storage device 210 except that it includes a cover 722. The cover 722 is similar to the cover 552 except that it includes an open lower end 724 which permits the article 212 to project beyond the base unit 102. As a result, even when the magnetic storage device 710 is in a closed state, as shown in FIG. 29, the magnetic storage device 710 permits a visual determination of whether the magnetic storage device 710 contains the article 212 while the magnet 106 prevents the accidental dislodgement of the article 212.

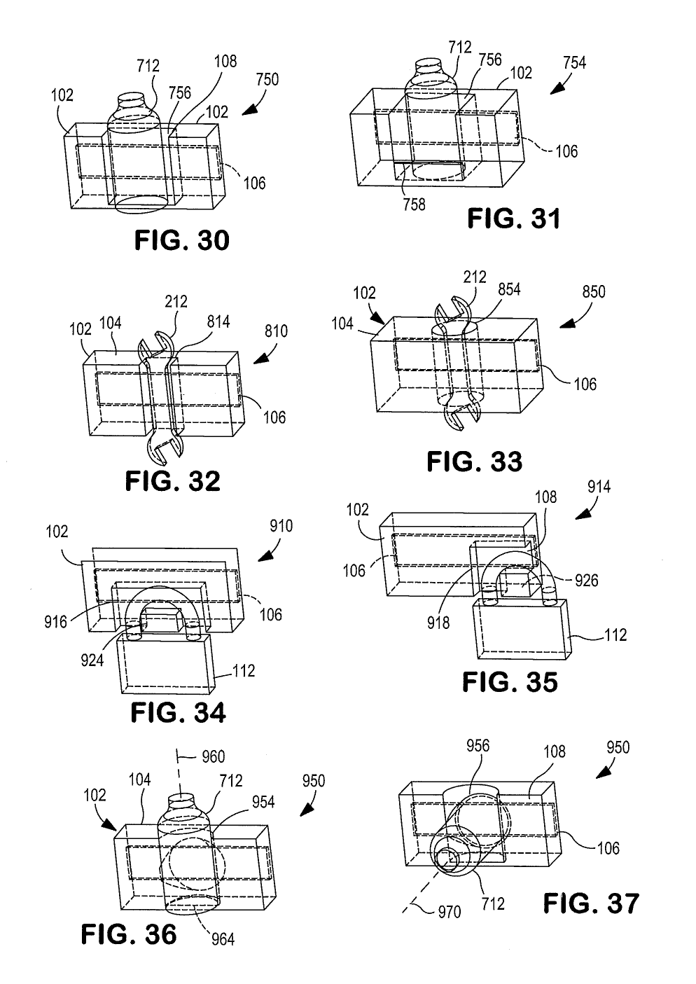

Referring now to FIGS. 30 and 31, two magnetic storage devices 750 and 754 are illustrated. Each of the magnetic storage devices 750 and 754 include a base unit 102 in which is formed an open topped cove 756 located in front of the magnet 106. The magnetic storage device 754 additionally includes a front wall run 758 to further assist in retaining an article 712 within the cove 756. In such implementations, the magnet 106 inhibits the accidental rotation of the article 712 about an axis aligned parallel to the front face 108 to inhibit axial dislodgement of the article 712 (shown as a bottle or container). Although the cove 756 is illustrated as being rectangular in shape, in other implementations the cove 756 may be semicircular or of some other shape or configuration, depending on the shape and configuration of the article 712.

Referring now to FIG. 32, a magnetic storage device 810 is illustrated. The magnetic storage device 810 includes a base unit 102 and a vertical channel 814. The vertical channel 814 extends into the back 104, such that it is located in front of the magnet 106. The channel 814 receives the article 212 and the article 212 is allowed to project both above and below the base unit 102. As a result, the base unit 102 may be smaller and more compact. At the same time, the magnet 106 assists in retaining the article 212 in place using magnetic forces.

Referring now to FIG. 33, a magnetic storage device 850 is illustrated. The magnetic storage device 850 includes a base unit 102 and a vertical passage 854. The vertical passage 854 extends through the back 104 and completely surrounds the article 212. The vertical passage 854 is dimensioned such that the article 212 may completely pass through the passage 854 in a vertical direction when the base unit 102 is mounted against a vertical surface, such as a wall. The vertical passage 854 extends in front of the magnet 106 wherein the magnet 106 applies magnetic forces to the article 212 to inhibit withdrawal of the article 212 from the vertical passage 854. Although the vertical passage 854 is illustrated as a cylindrical passage, in other implementations, the vertical passage 854 may have, other sizes and shapes depending upon the particular size or shape or configuration of the article 212. As in all of the examples illustrated, the article 212 can vary.

Referring now to FIGS. 34 and 35, two magnetic storage devices 910 and 914 are illustrated. The magnetic storage devices 910 and 914 are similar to one another and each includes a base unit 102 and an inset cavity 916, 918 respectively. The inset cavity 916 extends about a protuberance 924 from which the article 112 hangs. The inset cavity 918 extends partially about a protuberance 926 from which the article 112 hangs. The protuberances 924 and 926 are similar to the protuberance 114 described above, in that each of the protuberances 924 and 926 hold the article 112 in a manner that article 112 is free to rotate about an axis aligned parallel to the front face 108 except for resistance against such rotation provided by the magnet 106. Because each of the protuberances 924 and 926 are contained within one of the inset cavities 916, 918, the protuberances 924 and 926 do not project beyond the base unit 102 where they may undesirably catch upon external products or other items during shipping, display or use. In FIGS. 34 and 35, each of the protuberances 924 and 926 further permit the article 112 to hang beyond the base unit 102 for greater visual inspection of the article 112 and to provide the base unit 102 with greater compactness.

Referring now to FIGS. 36 and 37, a magnetic storage device 950 is illustrated. The magnetic storage device 950 is useful for storing or containing an article 712 such as a bottle. The magnetic storage device 950 includes a base unit 102 and two openings 954 and 956. The opening 954 includes a semi-cylindrical opening extending into the back 104 and located in front of both the magnet 106 and the opening 956. The opening 954 is centered along a vertical axis 960 (the central axis of the semi-cylindrical opening). The opening 954 facilitates reception of the article 712 with the centerline of the article 712 extending parallel to or coincident with the vertical axis 960. In FIG. 36, the opening 954 is blind in that it terminates at a lower ledge 964 which supports the article 712. In other implementations, the opening 954 may include a passage completely extending vertically across the back 104, which would allow the article 712 to project beyond the bottom of the back 104 when in the vertical orientation shown in FIG. 36.

The opening 956 includes a cylindrical opening projecting into the back 104 and in front of the magnet 106. The opening 956 extends through the back or floor of the opening 954. The opening 956 is centered along a horizontal axis 970 which is aligned perpendicular to the front face 108 and perpendicular to the vertical axis 960. The opening 956 is configured to receive an axial end of the article 712. The opening 956 facilitates retention of the article 712 with the article 712 projecting outward and orthogonal from the base unit 102. The magnet 106 assists in retaining the article 712 to inhibit the accidental dislodgement of the article 712.

Still referring to FIGS. 36 and 37, the openings 954 and 956 allow the article 712 to be selectively stored in either a vertical orientation, shown in FIG. 36, or a horizontal orientation, shown in FIG. 37. The openings 954 and 956 allow such a choice without increasing the overall footprint of the associated storage receptacle provided on the back 104. Although the openings 954 and 956 are illustrated as being configured to receive an article 712 having a cylindrical shape, the openings 954 and 956 may be configured to receive other articles, such as a hole saw, drill bits, sockets and the like.

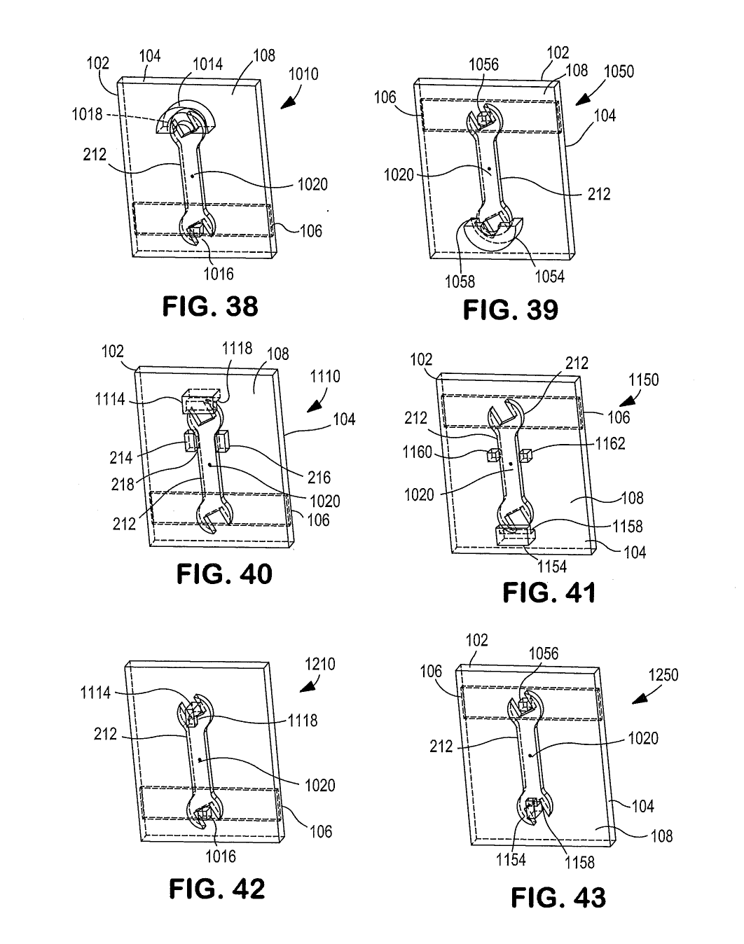

Referring now to FIG. 38, a magnetic storage device 1010 is illustrated. The magnetic storage device 1010 includes a base unit 102 and two protuberances 1014 and 1016. The base unit 102 was described above with respect to FIG. 12. The protuberance 1014 projects out from the front face 108 of the back 104 to support a portion of an article 212. The protuberance 1014 forms a hollow interior cavity 1018 that faces downward and is configured to removably receive a portion of the article 212. The cavity 1018 is sufficiently sized to permit the article 212 to rotate about an axis aligned parallel to the front face 108 of the back 104 except for resistance against such rotation provided by the magnet 106. In FIG. 38, the cavity 1018 is shown as a semi-spherical cylindrical cavity centered about an axis aligned perpendicular to the front face 108. In other implementations, the cavity 1018 can have some other configuration, depending on the shape of the article 212.

The protuberance 1016 includes a projection extending out from the front face 108 and is located opposite to a portion of the article 212 as compared to the protuberance 1014. The protuberance 1016 is aligned along an axis perpendicular to the front face 108. The protuberance 1016 is configured to be received by a portion of the article 212 and is sufficiently spaced from the protuberance 1014 to facilitate pivoting of the article 212 about an axis aligned parallel to the front face 108. Although the protuberance 1016 is shown as a rectangular post, it could have some other cross-sectional shape or configuration, depending on the configuration of the article 212.

Still referring to FIG. 38, the article 212 has a center of mass 1020 (a center of gravity), wherein the protuberance 1016 is on a first side of the center of mass 1020 while the magnet 106 is on a second side of the center of mass 1020. Because the magnet 106 is located on an opposite side of the center of mass 1020 from the protuberance 1016, the magnet 106 inhibits inadvertent pivoting or rotation of the article 212 about the center of mass 1020. As a result, the protuberances 1014 and 1016 cooperate to support the article 212 and to permit the article 212 to be rotated in a clockwise direction outward away from the front face 108 for withdrawal of the article 212 from the cavity 1018 and off of the protuberance 1016. The magnet 106 prevents inadvertent dislodgement of the article 212 from protuberance 1016.

Referring now to FIG. 39, a magnetic storage device 1050 is illustrated. The magnetic storage device 1050 includes a base unit 102 and two protuberances 1054 and 1056. The base unit 102 was described above with respect to FIG. 12. The protuberance 1054 projects out from the front face 108 and support a portion of the article 212. The protuberance 1054 forms a hollow interior cavity 1058 that faces upward and is configured to removably receive a portion of the article 212. The cavity 1058 is sufficiently sized to permit the article 212 to rotate about an axis aligned parallel to the front face 108 of the back 104 except for resistance against such rotation provided by the magnet 106. In FIG. 39, the cavity 1018 includes a semi-spherical cylindrical cavity centered about an axis aligned perpendicular to the front face 108. In other implementations, the cavity 1018 can have some other configuration depending on the shape and configuration of the article 212.

The protuberance 1056 includes a projection extending out from the front face 108 and located opposite to a portion of the article 212. In FIG. 39, the protuberance 1056 is aligned along an axis aligned perpendicular to the front face 108. The protuberance 1056 is configured to contact a portion of the article 212 and is sufficiently spaced from the protuberance 1054 to facilitate pivoting of the article 212 about an axis aligned parallel to the front face 108. Although the protuberance 1056 is shown as a rectangular post, in other implementations, the protuberance 1056 may have some other cross-sectional shape or configuration depending on the configuration of the article 212.

Still referring to FIG. 39, the article 212 has a center of mass 1020 (a center of gravity) wherein the protuberance 1054 is on a first side of the center of mass 1020 and the magnet 106 is on a second side of the center of mass 1020. Because the magnet 106 is located on an opposite side of the center of mass 1020 than the protuberance 1058, the magnet 106 inhibits inadvertent pivoting or rotation of the article 212 about center of mass 1020. As a result, the protuberances 1054 and 1056 cooperate to support the article 212 and permit the article 212 to be rotated in a counter-clockwise direction outward away from the front face 108 for withdrawal of the article 212 from the cavity 1058 and off of the protuberance 1056. The magnet 106 prevents inadvertent dislodgement of the article 212 from the protuberance 1056.

Referring now to FIG. 40, a magnetic storage device 1110 is illustrated. The magnetic storage device 1110 is similar to the magnetic storage device 210 except that it includes an additional protuberance 1114 besides protuberances 214 and 216. The magnetic storage device 1110 also includes a magnet 106 formed in the base unit 102. The magnet 106 is located on an opposite side of the protuberance 1114. The protuberance 1114 includes a projection extending outward from the front face 108 so as to form a cavity 1118 which faces in a downward direction. In FIG. 40, the protuberance 1114 includes an inverted L-shaped member forming the cavity 1118. In other implementations, the cavity 1118 may be provided by other configurations of the protuberance 1114. The cavity 1118 receives a portion of the article 212. The article 212 has a center of mass 1020. The cavity 1118 is sufficiently sized to permit the article 212 to be rotated or pivoted about a horizontal axis aligned parallel to the front face 108 so as to dislodge the article 212 from the protuberances 214 and 216, as well as from the cavity 1118 formed in the protuberance 1114. Because the magnet 106 is located on the opposite side of the center of mass 1020 of the article 212, and also on the opposite side of the two protuberances 214 and 216 as well as the cavity 1118, the magnet 106 inhibits pivoting of the article 212. The magnet 106 further inhibits accidental dislodgement of the upper portion of the article 212 resting upon the two protuberances 214 and 216.

Referring now to FIG. 41, a magnetic storage device 1150 is illustrated. The magnetic storage device 1150 includes a base unit 102 and three protuberances 1154, 1160 and 1162. The protuberance 1154 includes a projection extending out from the front face 108 of the back 104 so as to form a cavity 1158. The cavity 1158 receives a lower end portion of the article 212. The cavity 1158 is sufficiently wide enough to permit pivoting or rotation of the article 212 in a counter-clockwise direction away from the front face 108. In FIG. 41, the protuberance 1154 is an L-shaped member forming the cavity 1158. In other implementations, the procurement 1154 may have other configurations for receiving a lower portion of article 212.

The protuberances 1160 and 1162 include projections extending out from the front face 108 so as to engage opposite sides of the article 212 and both serve to inhibit rotation of the article 212 about an axis aligned perpendicular to the front face 108. In FIG. 41, the article 212 has a center of mass 1020. The two protuberances 1160 and 1162 are located at or above the center of mass 1020. Because the magnet 106 is located on the opposite side of the center of mass 1020 of the article 212, and also on the opposite side of the three protuberances 1160, 1162 and 1154 as well as the cavity 1158, the magnet 106 inhibits accidental dislodgement of the article 212 from the cavity 1158.

Referring now to FIG. 42, a magnetic storage device 1210 is illustrated. The magnetic storage device 1210 is similar to the magnetic storage device 1110 except that the magnetic storage device 1210 omits the two protuberances 214 and 216. Instead, the magnetic storage device 1210 has a protuberance 1016 and a protuberance 1114. The two protuberances 1016 and 1114 not only receive a portion of the article 212 but they also extend through or within a portion of the article 212 for enhanced securement of the article 212.

Referring now to FIG. 43, a magnetic storage device 1250 is illustrated. The magnetic storage device 1250 is similar to the magnetic storage device 1150 except that the magnetic storage device 1250 omits the two protuberances 1160 and 1162. Instead, the magnetic storage device 1250 includes a protuberance 1056 and a protuberance 1154. The two protuberances 1056 and 1154 not only receive a portion of the article 212 but they also extend through or within a portion of the article 212 for enhanced securement of the article 212. As with the magnetic storage devices 1010 and 1050, the magnets 106 in the magnetic storage devices 1210 and 1250 inhibit accidental dislodgement of the article 212 from the two protuberances 1016 and 1114 and 1056 and 1154, respectively.

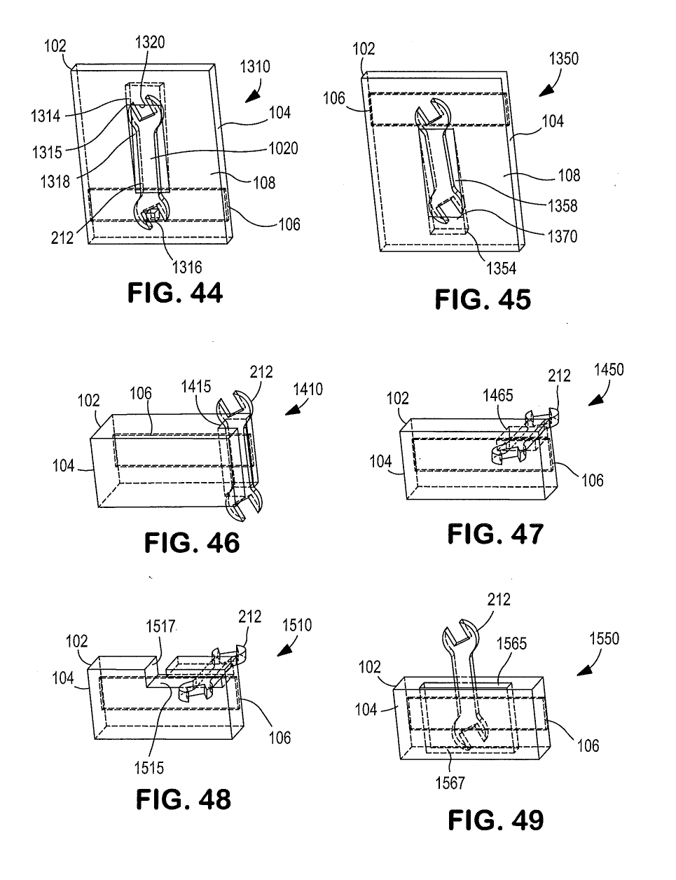

Referring now to FIG. 44, a magnetic storage device 1310 is illustrated. The magnetic storage device 1310 includes a base unit 102 and two protuberances 1314 and 1316. The protuberance 1314 projects forwardly from a recessed portion 1318 formed in the front face 108 of the back 104 to form a pocket 1320. The pocket 1320 is configured to receive an upper portion of the article 212 (shown as a wrench). The pocket 1320 is sufficiently large so as to permit pivoting of the article 212 about a horizontal axis aligned parallel to the front face 108 for dislodgement of the article 212 from the protuberance 1314 and withdrawal from the pocket 1320.

The protuberance 1316 includes a projection, such as a post, extending from the front face 108 so as to engage with a lower portion of the article 212. The protuberance 1316 is configured to be received within a lower portion of the article 212. In other implementations, the protuberance 1316 may alternatively merely engage with or receive a portion of the article 212.

As noted above, the article 212 has a center of mass 1020. The magnet 106 is located on an opposite side of center of mass 1020 as pocket 1320. As a result, magnet 106 better inhibits pivoting of article 212 to prevent accidental dislodgement of article 212 from protuberance 1316. At the same time, because article 212 is merely held onto protuberance 1316 by magnetic forces from magnet 106, article 212 may be easily removed from base unit 102 when desired.

Referring now to FIG. 45, a magnetic storage device 1350 is illustrated. The magnetic storage device 1350 includes a base unit 102 and a protuberance 1354. The protuberance 1354 projects forwardly from a recessed portion 1358 of the front face 108 of the back 104 to form a pocket 1370. The pocket 1370 is configured to receive a lower portion of the article 212. The pocket 1370 is sufficiently large so as to permit pivoting of the article 212 about a horizontal axis aligned parallel to the front face 108 for withdrawal of the article 212 from the pocket 1370. As noted above, the article 212 has a center of mass 1020. The magnet 106 is located on an opposite side of the center of mass 1020 as well as from the pocket 1370. As a result, the magnet 106 inhibits pivoting of the article 212 to prevent accidental dislodgement of the article 212 from the pocket 1370.

Referring now to FIG. 46, a magnetic storage device 1410 is illustrated. The magnetic storage device 1410 includes a base unit 102, a back 104, and a passage 1415. The passage 1415 extends through the base unit 102 in a vertical direction approximate to the magnet 106. The passage 1415 is configured to receive at least a portion of the article 212. The magnet 106 assists in maintaining the article 212 within the passage 1415 and releasably secures it to the back 104. As a result, the article 212 may be easily withdrawn from the passage 1415.

Referring now to FIG. 47, a magnetic storage device 1450 is illustrated. The magnetic storage device 1450 is similar to the magnetic storage device 1410 except that the magnetic storage device 1450 includes a passage 1465 which horizontally extends through the back 104 of the base unit 102. The passage 1465 receives and maintains the article 212 in a horizontal orientation. The magnet 106 applies magnetic forces to the article 212 to inhibit accidental dislodgement of the article 212 from the passage 1465.

Referring now to FIG. 48, a magnetic storage device 1510 is illustrated. The magnetic storage device 1510 includes a base unit 102, a back 104, and a passage 1515. The passage 1515 extends horizontally through the back 104 of the base unit 102 and includes an upward facing mouth or opening 1517. The passage 1515 receives the article 212 either in a horizontal direction or vertically through the mouth or opening 1517. The passage 1515 enables the article 212 to be horizontally slid in to a position opposite to the mouth or opening 1517 and to be subsequently lifted through the mouth or opening 1517. The magnet 106 inhibits inadvertent movement of the article 212 horizontally out of the passage 1515 or vertically through mouth or opening 1517.

Referring now to FIG. 49, a magnetic storage device 1550 is illustrated. The magnetic storage device 1550 includes a base unit 102, a back 104, and a pocket 1565. The pocket 1565 extends vertically downward through the top of the base unit 102 parallel to the back 104 and terminates at a bottom floor 1567. The pocket 1565 receives the article 212. The magnet 106 inhibits accidental removal of the article 212 from the pocket 1565.

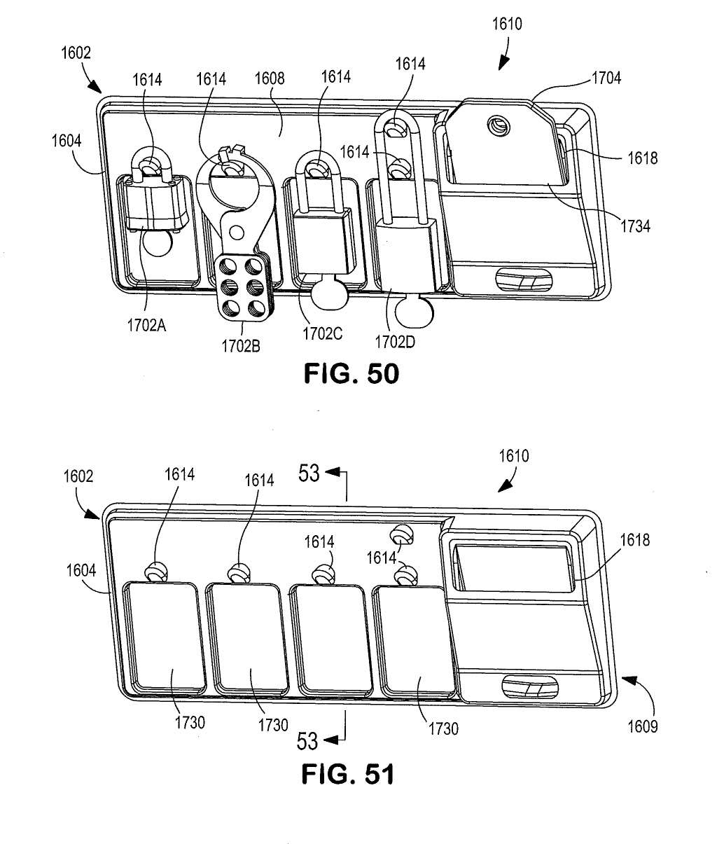

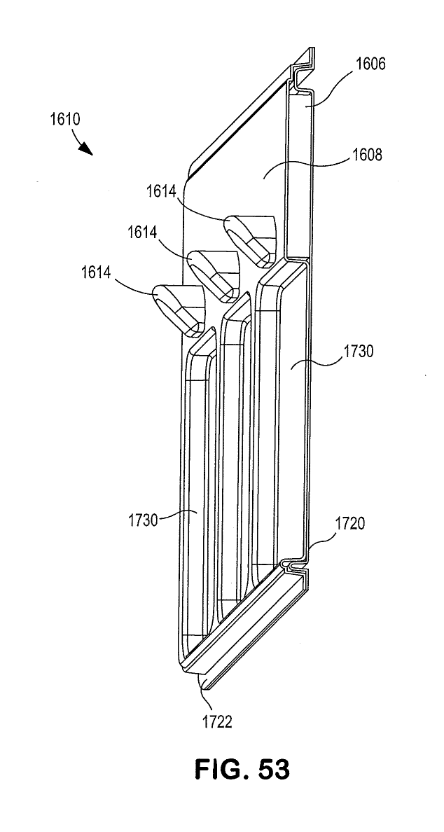

Referring now to FIGS. 50-53 another magnetic storage device 1610 is illustrated for storing and presenting articles 1702A, 1702B, 1702C, 1702D (collectively referred to as articles 1702) and article 1704. Each of the articles 1702 has a magnetic affinity such that each is attracted to one or more magnets. In FIG. 50, the articles 1702A, 1702C and 1702D are shown as padlocks. The article 1702B is shown as a multi-lockout. The article 1704 is a tag having no magnetic affinity. In other implementations, the magnetic storage device 1610 may hold and store other articles having magnetic affinities, as well as other non-magnetic or nonferrous articles.

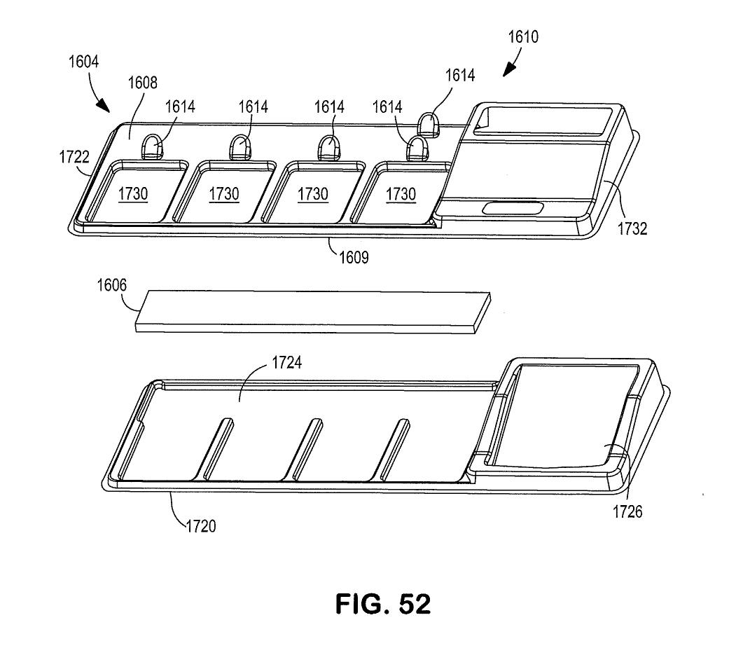

The magnetic storage device 1610 includes a base unit 1602, four protuberances 1614, and a card or tag holder pocket 1618. The base unit 1602 includes a back 1604 and a magnet 1606 (see FIG. 52). The back 104 contains and holds the magnet 106. The back 1604 is configured to be supported against a vertical plane or wall, either through use of the magnet 1606 or through use of a hang hole, hanger, fastener or other mounting mechanism known to those skilled in the art.

Referring now to FIGS. 51 and 52, the back 1604 includes a two-piece assembly including a base 1720 and a tray 1722. The base 1720 and the tray 1722 can be welded, fastened, snapped or otherwise joined to one another with the magnet 1606 positioned therebetween. In another implementation, the back 1604 may include a body having an opening into which the magnet 1606 can be inserted. In FIG. 52, the base 1720 includes a recess or channel 1724 which receives and retains in place magnet 1606. Tray 1720 further includes a back portion 1726 of pocket 1618.

Referring again to FIG. 52, the tray 1722 of the magnetic storage device 1610 has a back 1604 and a front face 1608. The tray 1722 further includes four cavities 1730, 1730, 1730 and 1730, and a front pocket 1732. Each of the four cavities 1730, 1730, 1730 and 1730 extend below one of the four protuberances 1614, 1614, 1614 and 1614 for partially receiving and framing the articles 1702. The front pocket 1732 cooperates with a back portion 1726 to form the pocket 1618 which includes an open slot 1734, see FIG. 50, for receiving tags or cards 1704.

Referring again to FIG. 52, the magnet 106 includes an elongate magnetic strip, bar or band positioned within back 1604. In some implementations, the magnet 1606 may be supported or mounted along a back face 1609 of the back 1604. The magnet 106 has a sufficient magnetic strength so as to magnetically attract and releasably hold articles 1702 supported along the back 1604.

Still referring to FIG. 52, each of the four protuberances 1614, 1614, 1614 and 1614 includes a projection or some other structure extending from the front face 1608 so as to engage a portion of the articles 1702. Each of the articles 1702 has a magnetic affinity. In FIG. 52, each of the four protuberance 1614 includes a post which is encircled by a portion of the article 1702 such that each of the articles 1702 hangs from each of the four protuberances 1614. Each of the four protuberances 1614 is configured such that one of the articles 1702 is held, but is free to rotate about an axis aligned parallel to the front face 1608 except for resistance against such rotation provided by the magnet 1606. As a result, the magnet 1606 not only assists in retaining the articles 1702 on the four protuberances 1614 to prevent accidental dislodgement of the articles 1702 from the respective protuberance 1614, but also further inhibits rotation of each of the articles 1702 about a horizontal axis. Although each of the four protuberances 1614 is illustrated as having a semi-cylindrical shape, in other implementations, each of the four protuberances 1614 may have some other cross-sectional shape and/or configuration. For example, a protuberance 1614 may have a circular, a rectangular or some other shape. In some implementations, each of the four protuberances 1614 may be a hook.

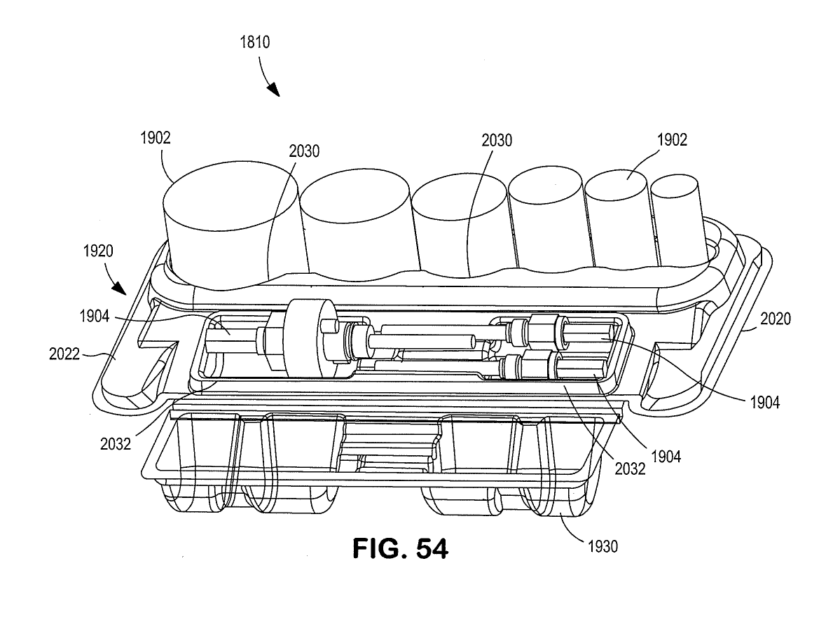

Referring now to FIGS. 54-57, another magnetic storage device 1810 is illustrated. The magnetic storage device 1810 is capable of holding a plurality of different shaped articles 1902 and 1904. In FIG. 54, six of the articles 1902 are shown. The articles 1902 are depicted as cylindrical objects of varying diameters. For example, the articles 1902 can be hole saws. Each of the articles 1902 has a magnetic affinity. Desirably, at least a portion of each of the articles 1902 is formed from a ferrous material. Two of the articles 1904 are shown and are depicted as arbors, each having an elongated configuration. The article 1904 can be used with one of the articles 1902. The articles 1904 do not have such a magnetic affinity. In other implementations, the magnetic storage device 1810 may hold a combination of different articles 1902 and 1904, which have and do not have a magnetic affinity.

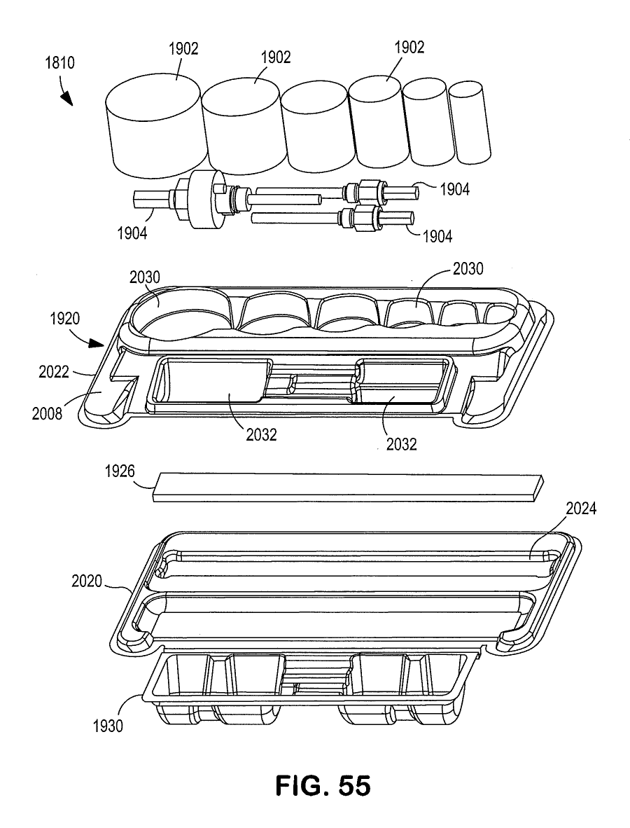

Referring to FIG. 55, the magnetic storage device 1810 includes a back 1920, a magnet 1926 and a cover 1930. The back 1920 is a two-piece assembly including a base 2020 and a tray 2022, wherein the base 2020 and the tray 2022 are secured together. For example, the base 2020 and the tray 2022 can be welded, fastened, snapped or otherwise joined to one another with the magnet 1926 positioned therebetween. In another implementation, the back 2020 may include a body having an opening into which the magnet 1926 is inserted. In FIG. 55, the base 2020 includes a recess or channel 2024 which receives and retains in the magnet 1926 in place. In other implementations, the magnetic storage device 1810 may omit the base 2020, wherein the magnet 1926 is otherwise adhered to the tray 2022.

Still referring to FIG. 55, the tray 2022 has a front face 2008 into which are formed a plurality of recesses, cavities or receptacles 2030, and at least two recesses, cavities or receptacles 2032. The receptacles 2030 are configured to receive the articles 1902 and support articles opposite to the magnet 1926, which is retained within the channel 2024. As a result, the magnet 1926 assists in retaining the articles 1902 within the receptacles 2030 regardless of the orientation of the magnetic storage device 1810. The receptacles 2032 are spaced apart from the magnet 1926. In one implementation, the receptacles 2032 are configured to contain articles that do not have a magnetic affinity. In another implementation, the receptacles 2032 are configured to receive articles that do have a magnetic affinity, but which are not sufficiently close to the magnet 1926 to be held by the magnet 1926.

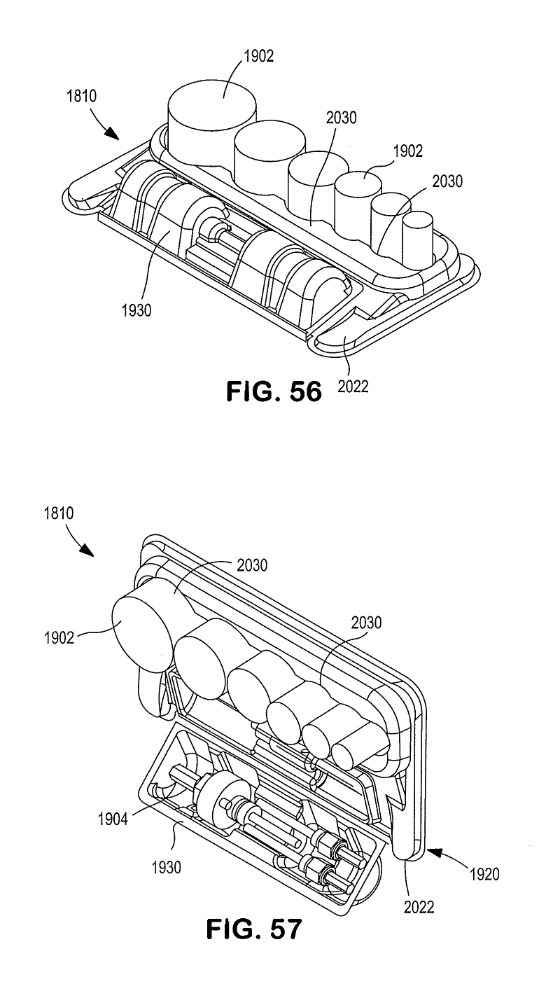

The cover 1930 includes a structure which is pivotably coupled to or hinged to the base 2020. In FIGS. 55-57, the cover 1930 is integrally formed as part of a single unitary body with the base 2020. A living hinge can be formed between the base 2020 and the cover 1930 to join the two members. The cover 1930 pivots between a first position and a second position, see FIGS. 56 and 57. In the first position, the cover 1930 covers or overlaps the recesses, cavities or receptacles 2032 and encloses the articles 1904, see FIG. 57. In the second position, the cover 1930 is open and does not cover or surround the recesses, cavities or receptacles 2032, see FIGS. 54, 55 and 57. In the second position, the cover 1930 is inverted to form a trough below the recesses, cavities or receptacles 2032 when the back 1920 is in a vertical orientation or extends in a vertical plane. As shown in FIGS. 54 and 56, when the magnetic storage device 1810 is in a horizontal orientation, the cover 1930 may be moved from a closed state, see FIG. 56, to an open state, see FIG. 54, wherein the articles 1904 are retained within the recesses 2032 under the force of gravity. As shown in FIG. 57, when the magnetic storage device 1810 is alternatively used in a vertical orientation, such as when the magnetic storage device 1810 is mounted to or otherwise supported by a vertical wall or panel, the cover 1930 serves as a trough to contain the articles 1904. Otherwise, the articles 1904 would not otherwise be held by the magnet 1926 and would fall out of the magnetic storage device 1810.

Referring again to FIG. 55, the magnet 1926 is depicted as an elongate magnetic strip, bar or band. The magnet 1926 is positioned within the back 1920. In some implementations, the magnet 1926 may be supported or mounted along the back face of the back 1920 rather than being contained within or as a part of the base 2020. In such implementations, the cover 1930 may alternatively be pivotally coupled to the tray 2022. The magnet 1926 has a sufficient magnetic strength so as to magnetically attract and releasably hold the plurality of articles 1902 supported along the back 1920.

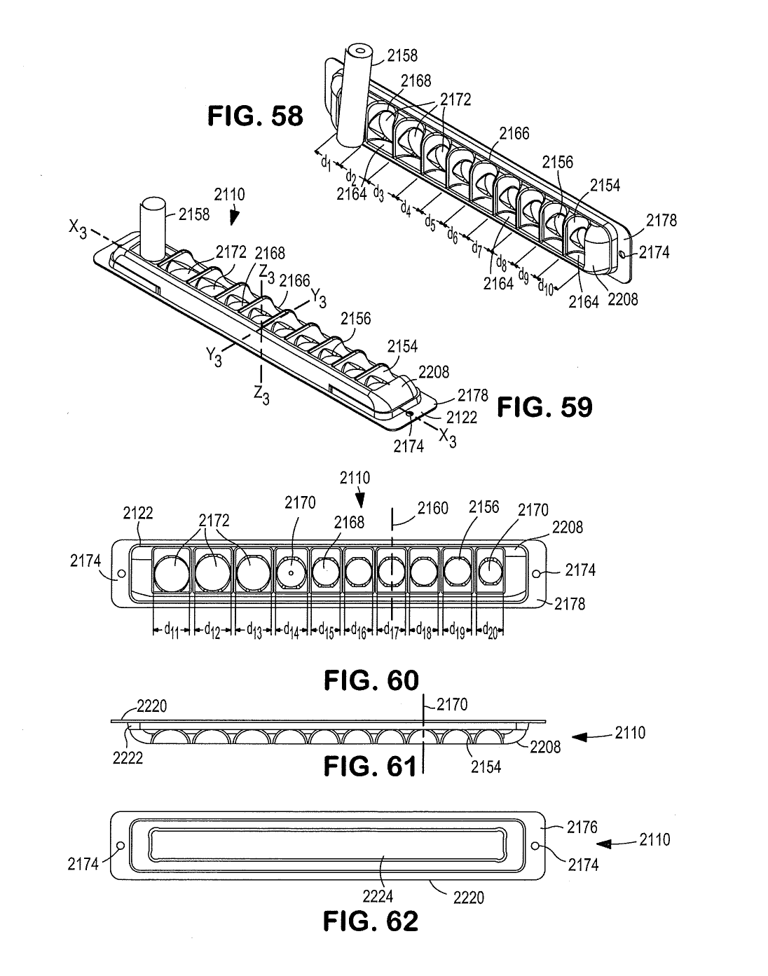

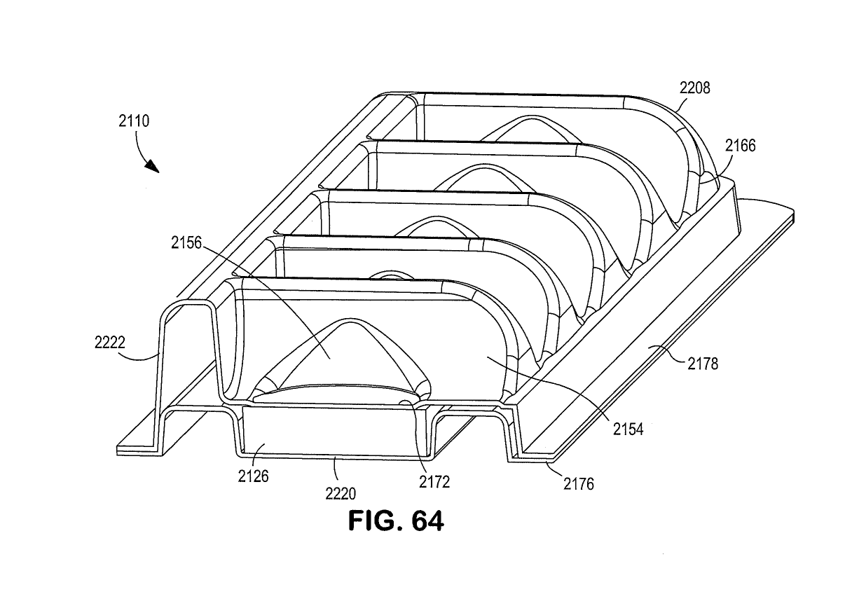

Referring now to FIGS. 58-64, another magnetic storage device 2110 is illustrated. The magnetic storage device 2110 is capable of retaining a single article 2158 or a plurality of articles 2158 when each article 2158 has a magnetic affinity. In FIGS. 58-64, the magnetic storage device 2110 has been constructed to hold or retain a plurality of articles 2158 in a row. The magnetic storage device 2110 has a longitudinal central axis X3-X3, a vertical central axis Y3-Y3, and a transverse central axis Z3-Z3, see FIG. 59. The magnetic storage device 2110 includes a magnet 2126, a base 2220 having a channel 2224 formed therein, and a tray 2222, see FIG. 60. The base 2220 can be formed from a thermoplastic or from some other material. Likewise, the tray 2222 can be formed from a thermoplastic or from some other material.

The channel 2224 is sized and configured to receive and retain the magnet 2126. The magnet 2126 can vary in size, shape and design. Desirably, the magnet 2126 is a three dimensional magnet. The magnet 2126 is aligned along the longitudinal central axis X3-X3 of the magnetic storage device 2110. The magnet 2126 has a north pole and an oppositely aligned south pole.

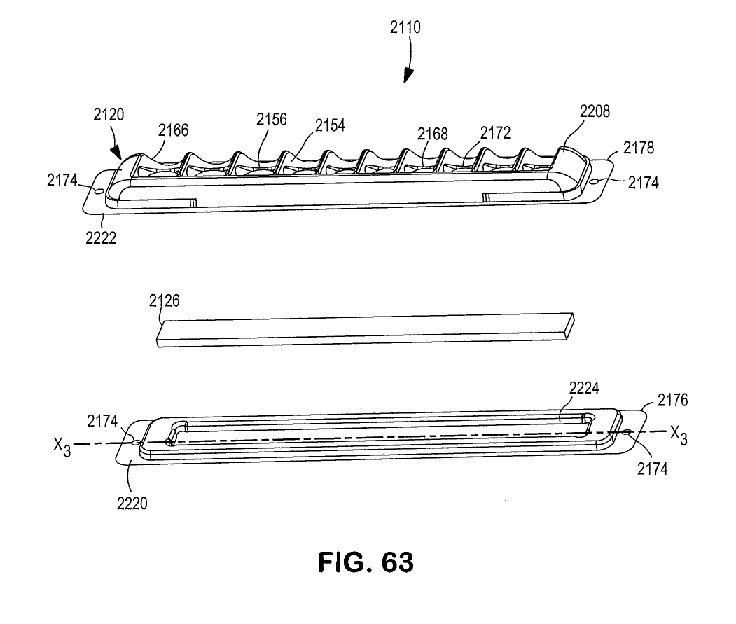

The magnetic storage device 2110 also has a back 2120, see FIG. 63. The back 2120 can be a two-piece assembly which includes the base 2220 and the tray 2222. The tray 2222 engages with the base 2220. The base 2220 and the tray 2222 are secured together. For example, the base 2220 and the tray 2222 can be welded, fastened, snapped or otherwise joined to one another with the magnet 2126 sandwiched in between. Alternatively, the back 2120 may include a body having an opening into which the magnet 2126 can be inserted. In FIG. 63, the base 2220 includes a recess or channel 2224 which receives and retains the magnet 2126 in place. In other implementations, the magnetic storage device 2110 may omit the base 2220, wherein the magnet 2126 is otherwise adhered to the tray 2222.

Referring now to FIGS. 58-63, the tray 2222 has a front face 2208 into which a first opening 2154 and a second opening 2156 are formed. The first and second openings, 2154 and 2156 respectively, can vary in size and configuration depending upon the shape of the articles 2158 they need to hold or retain. Desirably, the magnetic storage device 2110 has at least one first opening 2154 and at least one second opening 2156 formed in the front face 2208 of the tray 2222. More desirably, the magnetic storage device 2110 has a plurality of first openings 2154 and a plurality of second openings 2156 are formed in the front face 2208 of the tray 2222. By “plurality” it is meant three or more. The number of first openings 2154 corresponds to the number of second openings 2156. Ten first openings 2154 and ten second openings 2156 are shown in FIGS. 58-63. All of the first openings 2154 are aligned in a row and all of the second openings 2156 are aligned in a row. Both rows are aligned along the longitudinal central axis X3-X3.

Referring now to FIGS. 58-60 and 63, a plurality of the first openings 2154 are shown with each of the first openings 2154 having a semi-cylindrical configuration. By “semi-cylindrical” it is meant a cylindrical opening having a circular arc of 180 degrees. Each of the first openings 2154 is shaped like half of a cylinder. Each of the first openings 2154 has a lower ledge 2164 in the form of an arc spanning 180 degrees. The semi-cylindrical configuration extends into the back 2120, see FIG. 63. Each of the first openings 2154 has an upper edge 2166 which is aligned opposite to the lower edge 2164. The upper edge 2166 is open. By “open” it is meant that the upper edge 2166 does not contain any structure, such as a wall or flange. The upper edge 2166 forms a 180 degrees semi-circular opening in the tray 2222 with no obstructions.

Each of the first openings 2154 is positioned in front of the magnet 2126. Each of the first openings 2154 has a side wall 2168. At least a portion of each of the side walls 2168 overlay the magnet 2126. Each of the first openings 2154 is designed to retain a cylindrically shaped article 2158. Each of the first openings 2154 overlies and intersects one of the second openings 2156. Each of the first openings 2154 is aligned perpendicular or at 90 degrees to one of the second openings 2156. The diameter of each of the first openings 2154 can be the same or can vary. As shown in FIG. 58, each of the first openings 2154 has a difference size diameter, indicated as: d1, d2, d3, d4, d5, d6, d7, d8, d9, d10. The diameter d1 is the largest and the diameters decrease in size as they approach diameter d10.

When a plurality of the first openings 2154 are aligned in a row, then at least one of the first openings 2154 can be of a different size than another of the first openings 2154. Alternatively, when a plurality of the first openings 2154 are aligned in a row, then at least one of the first openings 2154 can be of the same size as another of the first openings 2154. It should be noted that two or more of the diameters can be of the same size, if desired.

All of the first openings 2154 are aligned perpendicular to the longitudinal central axis X3-X3 and are aligned parallel to the vertical central axis Y3-Y3 of the magnetic storage device 2110, see FIGS. 58 and 59. In addition, the orientation of each of the first openings 2154 is centered along an axis 2160 of each of the first openings 2154, see FIG. 60. In FIG. 60, the axis 2160 for one of the first openings 2154 is shown. Each of the first openings 2154 is designed to receive a cylindrical article 2158, such as a hole saw, a socket, a cylindrical container or the like, with the centerline of the article 2158 extending parallel to or coincident with the axis 2160.

Still referring to FIGS. 58-60, each of the first openings 2154 is blind in that each of the first openings 2154 terminates at a lower ledge 2164. The lower ledge 2164 functions to support an article 2158 in each of the first openings 2154. In other words, the article 2158 cannot extend beyond the lower ledge 2164. The lower ledge 2164 serves as a bottom for each article 2158 that is retained in each of the first openings 2154 formed in the magnetic storage device 2110. Alternatively, each of the first openings 2154 may include a passage completely extending vertically across the back 2120, allowing the articles 2158 to project beyond the bottom of the back 2120, when in the vertical orientation, similar to that shown in FIG. 36.

Referring now to FIGS. 58-61, each of the second openings 2156 is also designed to hold or retain a cylindrically shaped article 2158. Each of the second openings 2156 includes a cylindrical opening having a bottom wall 2172. The bottom wall 2172 of each of the second openings 2156 is coincident with the side wall 2168 of each of the first openings 2154. By “coincident” it is meant occupying the same area in space. The bottom wall 2172 can vary in thickness. The thickness of the bottom wall 2172 of each of the second openings 2156 can range from between about 0.001 inches to about 0.1 inches. Desirably, the thickness of the bottom wall 2172 of each of the second openings 2156 can range from between about 0.007 inches to about 0.05 inches. More desirably, the thickness of the bottom wall 2172 of each of the second openings 2156 can range from between about 0.01 inches to about 0.03 inches.

The bottom wall 2172 functions to prevent an article 2158 positioned in each of the second openings 2156 from directly contacting the magnet 2126. This is important for besides improving the aesthetic appearance of the magnetic storage device 2110, it also prevents the magnet 2126 from marking the articles and prevents liquids from infiltrating the device. The bottom wall 2172 acts as a barrier between the magnet 2126 and each of the articles 2158 positioned in one of the second openings 2156. Furthermore, the bottom wall 2172 is circular in configuration and spans an arc of 360 degrees. The bottom wall 2172 of each of the second openings 2156 forms a side wall of each of the first openings 2154. This is very important because it increases the aesthetic appearance of the magnetic storage device 2110 and reduces the cost of manufacturing the magnetic storage device 2110. Desirably, the bottom wall 2172 of each of the second openings 2156 is coincident with the side wall 2168 of each of the first openings 2154.

Each of the second openings 2156 has a diameter. The diameter of each of the second openings 2156 can be the same or can vary. As shown in FIG. 60, each of the second openings 2156 has a difference size diameter, indicated as: d11, d12, d13, d14, d15, d16, d17, d18, d19, d20. The diameter d11 is the largest and the diameters decrease in size as they approach diameter d20.

It should be noted that two or more of the diameters can be of the same size, if desired. Furthermore, the diameter d1 of the first opening 2154 should be equal to the diameter d11 of the second opening 2156. The diameter d2 of the first opening 2154 should be equal to the diameter d12 of the second opening 2156. This is true for the remaining first and second openings, 2154 and 2156 respectively.

All of the second openings 2156 are aligned perpendicular to the longitudinal central axis X3-X3 and parallel to the transverse central axis Z3-Z3 of the magnetic storage device 2110, see FIG. 59. In addition, the orientation of each of the second openings 2156 is centered along an axis 2170 of each of the second openings 2156, see FIGS. 60 and 61. In FIGS. 60 and 61, the axis 2170 for one of the second openings 2156 is shown. Each of the second openings 2156 projects into the back 2120 and overlies the magnet 2126. Each of the second openings 2156 extends through a side of each of the first openings 2154. Each of the second openings 2156 is centered along an axis 2170 which is aligned perpendicular to the front face 2208. The axis 2170 of each of the second openings 2156 is also aligned perpendicular to the axis 2160 of each of the first openings 2154. Each of the second openings 2156 is cylindrical in configuration and each is aligned perpendicular to and intersects one of the first openings 2154.

Each of the second openings 2156 is configured to receive an axial end of an article 2158. Desirably, each of the articles 2158 has a cylindrical configuration so as to receive a cylindrically shaped article 2158, such as a hole saw, a socket, a cylindrical container or the like. Each of the second openings 2156 facilitate retention of one of the articles 2158, with the article 2158 projecting outward and orthogonal from the back 2120, see FIG. 59. The magnet 2126 assists in retaining the articles 2158 to inhibit accidental dislodgement of the articles 2158 from the magnetic storage device 2110.

Each of the second openings 2156 facilitates reception of an article 2158, with the centerline of the article 2158 extending parallel to or coincident with the axis 2160. Each of the articles 2158 is positioned into one of the first or second openings to temporarily retain the article 2158 in the magnetic storage device 2110.

It should be understood that if an article 2158 is positioned in the first opening 2154, then a second article 2158 cannot be positioned in the second opening 2156 that intersects that first opening 2154, at the same time.

It should also be understood that when a plurality of first and second openings, 2154 and 2156 respectively, are present, that each pair of the first and second openings, 2154 and 2156 respectively, that intersect one another forms a set of openings which can retain an article 2158 of a given diameter.

The first and second openings, 2154 and 2156 respectively, allow an article 2158 to be selectively stored in either a vertical or a horizontal orientation. The first and second openings, 2154 and 2156 respectively, allow such a choice without increasing the overall footprint of the magnetic storage device 2110. In one implementation, the first and second openings, 2154 and 2156 respectively, are illustrated as being configured to receive a cylindrical article in the form of the container 712, see FIGS. 36 and 37. In other implementations, the first and second openings, 2154 and 2156 respectively, may be configured to receive other cylindrical articles, such as hole saws, drill bits, sockets and the like.

It should be understood that the magnet 2126 exerts a sufficient magnetic attraction on the articles 2158 when the articles 2158 are inserted into one of the first or second openings, 2154 or 2156 respectively, to temporarily retain the articles 2158 in the tray 2222. Furthermore, some of the articles 2158 can be retained in an upright position and some of the articles 2158 can be laying down.

Method of Attaching

Referring now to FIG. 63, the magnetic storage device 2110 contains a pair of apertures 2174, 2174. Each of the pair of apertures 2174, 2174 can be formed through each of the distal ends of the base 2220 and the tray 2222. The pair of apertures 2174, 2174 is aligned with the longitudinal central axis X3-X3 of the magnetic storage device 2110. Alternatively, the pair of apertures 2174, 2174 could be offset from the longitudinal central axis X3-X3, if desired. The pair of apertures 2174, 2174 allows the magnetic storage device 2110 to be mounted, using a pair of screws (not shown), to a structure or object. The structure could be the wall of a building, a door, a partition, etc. An object to which the magnetic storage device 2110 could be mounted includes but is not limited to: a stationary or movable tool chest, cabinet, work bench, etc. The magnetic storage device 2110 could be mounted horizontally, vertically or at any angle there between.

Each of the pair of apertures 2174, 2174 could also function as a way to hang and display the magnetic storage device 2110 in a retail store when it is being offered for sale. For example, the magnetic storage device 2110 could be hung from one of the apertures 2174 onto an elongated horizontal rod. The horizontal rod would serve as the support and several of the magnetic storage devices 2110 could be displayed, one behind the other. This presents a very neat ways to display the magnetic storage device 2110 for sale.

Lastly, referring again to FIG. 60, the base 2220 contains a flange 2176 and the tray 2222 contains a flange 2178. The two flanges 2176 and 2178 have coterminous edges. When the base 2220 is secured to the tray 2222, the two flanges 2176 and 2178 will become one member. The pair of apertures 2174, 2174 can be formed through both of the flanges 2176 and 2178. The flanges 2176 and 2178 can extend 360 degrees outward from the base 2220 and the tray 2222. The amount that different portions of the flanges 2176 and 2178 extend outward beyond the front face 2208 and/or the channel 2224 can vary. Typically, the flanges 2176 and 2178 extend outward to a greater extent at the opposite ends of the base 2220 and tray 2222, than at the sides. However, the flanges 2176 and 2178 could extend outward an equal amount at both the ends and at both of the sides, if desired.

Although the present disclosure has been described with reference to a number of embodiments, those skilled in the art will recognize that changes may be made in form and detail without departing from the spirit and scope of the claimed subject matter. For example, although different embodiments may have been described as including one or more features providing one or more benefits, it is contemplated that the described features may be interchanged with one another or alternatively be combined with one another in the described embodiments or in other alternative embodiments. Because the technology of the present disclosure is relatively complex, not all changes in the technology are foreseeable. The present invention described with reference to the embodiments and set forth in the following claims is manifestly intended to be as broad as possible. For example, unless specifically noted, the claims reciting a single particular element also encompass a plurality of such particular elements.

We claim:

1. A magnetic storage device capable of retaining at least one article having a magnetic affinity, said magnetic storage device comprising:
a) a magnet;
b) a base having a channel formed therein, said channel sized and configured to retain said magnet; and
c) a tray having a front face with a first opening and a second opening formed therein, said tray engaging said base and being held secure thereto with said magnet sandwiched in between, said first opening being semi-cylindrical in configuration and overlying said magnet, and said second opening being cylindrical in configuration and being aligned perpendicular to said first opening, said second opening having a bottom wall, and said magnet exerting a sufficient magnetic attraction on an article when said article is positioned into one of said first or second openings to temporarily retain said article in said magnetic storage device.

2. The magnetic storage device of claim 1 wherein said first opening has a lower ledge for supporting said article positioned therein.

3. The magnetic storage device of claim 1 wherein said second opening extends through said first opening and projects into said tray and in front of said magnet, and said bottom wall of said second opening spans an arc of 360 degrees.

4. The magnetic storage device of claim 1 wherein said first opening has an upper edge which creates a semi-circular opening with no obstructions.

5. The magnetic storage device of claim 1 wherein said second opening is located within said first opening and is configured to receive an axial end of an article.

6. The magnetic storage device of claim 1 wherein said bottom wall of said second opening is circular and spans an arc of 360 degrees, and said second opening can retain an article orthogonal to said tray.

7. The magnetic storage device of claim 1 wherein said second opening resides within said first opening, and said bottom wall of said second opening forms a side wall of said first opening.

8. The magnetic storage device of claim 1 wherein a plurality of first and second openings are present, and each pair of said first and second openings that intersect one another forms a set of openings which can retain an article of a given diameter.

9. The magnetic storage device of claim 1 wherein a plurality of said first openings are aligned in a row, and at least one of said first openings is of a different size than another of said first openings.

10. A magnetic storage device capable of retaining a plurality of articles, each article having a magnetic affinity, said magnetic storage device comprising:
a) an elongated magnet;
b) a base having an elongated channel formed therein, said channel sized and configured to retain said magnet; and
c) a tray having a front face with a plurality of first and second openings formed therein, said tray engaging said base and being held secure thereto with said magnet sandwiched in between, each of said first openings being semi-cylindrical in configuration and overlying said magnet, and each of said first openings having a sidewall, and each of said second openings being cylindrical in configuration and each being aligned perpendicular to and intersecting one of said first openings, said second opening having a bottom wall, and said magnet exerting a sufficient magnetic attraction on said plurality of articles when said articles are inserted into one of said first or second openings to temporarily retain said plurality of articles in said magnetic storage device.

11. The magnetic storage device of claim 10 wherein said bottom wall of each of the second openings is coincident with the side wall of each of the first openings.

12. The magnetic storage device of claim 10 wherein each said first openings has a lower ledge for supporting one of said plurality of articles and an open upper edge.

13. The magnetic storage device of claim 10 wherein said bottom wall of each said second openings is circular and spans an arc of 360 degrees, and each of said second openings can retain an article orthogonal to said tray.

14. The magnetic storage device of claim 10 wherein each said second openings resides within one of said first openings, and said bottom wall of each of said second openings forms a sidewall of each of said first openings.

15. The magnetic storage device of claim 10 wherein one of said second openings is of the same size as one of said first openings.

16. A magnetic storage device capable of retaining a plurality of articles, each article having a magnetic affinity, said magnetic storage device comprising:
a) a magnet;
b) a thermoplastic base having a channel formed therein, said channel sized and configured to retain said magnet; and
c) a thermoplastic tray having a front face with a plurality of first and second openings formed therein, said tray engaging said base and being held secure thereto with said magnet sandwiched in between, each of said first openings being semi-cylindrical in configuration and overlying said magnet, and each of said first openings having a sidewall, and each of said second openings being cylindrical in configuration and each being aligned perpendicular to and intersecting one of said first openings, each of said second openings having a bottom wall, and said magnet exerting a sufficient magnetic attraction on said plurality of articles when said articles are inserted into one of said first or second openings to temporarily retain said plurality of articles in said magnetic storage device.

17. The magnetic storage device of claim 16 wherein said bottom wall of each of the second openings is coincident with the side wall of each of the first openings.

18. The magnetic storage device of claim 16 wherein each said second openings extends through one of said first openings and projects into said tray and in front of said magnet, and said bottom wall of each of said second openings spans an arc of 360 degrees.

19. The magnetic storage device of claim 16 wherein each said first openings has an upper edge which creates a semi-circular opening with no obstructions.

20. The magnetic storage device of claim 16 wherein said bottom wall of each said second openings has a thickness ranging from between about 0.001 inches to about 0.01 inches.
